(19) United States
(12) Patent Application Publication
(10) Pub. No.: US 2025/0055810 A1
(43) Pub. Date: Feb. 13, 2025

(54) ULTRA-HIGH RADIX COMMUNICATION NETWORK

(71) Applicant: Marvell Asia Pte Ltd, Singapore (SG)

(72) Inventors: Kapil Vishwas Shrikhande, Berkeley, CA (US); Soren Pedersen, Austin, TX (US); Lenin Kumar Patra, Dublin, CA (US); Puneet AGARWAL, Santa Clara, CA (US)

(21) Appl. No.: 18/759,512

(22) Filed: Jun. 28, 2024

Related U.S. Application Data
(60) Provisional application No. 63/532,060, filed on Aug. 10, 2023.

(51) Int. Cl. H04L 49/111; H04L 49/109

(52) U.S. Cl. CPC H04L 49/111; H04L 49/109

(57) ABSTRACT

A communication network includes first switches interconnected with second switches. Each first switch includes a first integrated circuit (IC) switch chip, downlink ports, and uplink ports. Each second switch includes ports coupled to at least one uplink port of each of the first switches, and a second IC switch chip in an IC package. To permit each second IC switch chip to forward packets amongst a large number of first switches and to reduce a number of external interconnects of the IC package, each second IC switch chip includes sets of multiplexer/demultiplexer circuitry, each multiplexer/demultiplexer circuitry being coupled between an external interconnect, and a set of multiple internal network interfaces of the second IC switch chip. The multiplexer/demultiplexer circuitry demultiplexes a data stream from the external interconnect to multiple internal network interfaces, and multiplexes multiple data streams from the multiple internal network interfaces to the external interconnect.

### CROSS REFERENCES TO RELATED APPLICATIONS

This application claims the benefit of U.S. Provisional Patent App. No. 63/532,060, entitled “Scalable Data Center Network Architecture,” filed on Aug. 10, 2023, the disclosure of which is expressly incorporated herein by reference in its entirety.

### FIELD OF TECHNOLOGY

The present disclosure relates generally to communication networks, and more particularly to networks with multiple layers of switches.

### BACKGROUND

The approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Some networking applications require switching between a very large number of ports. For example, a typical data center includes a large number of servers, and switches to interconnect the servers and to communicatively couple the servers to outside network connections, such as backbone network links. As another example, some artificial intelligence/machine learning (AI/ML) systems comprise a large number of processors (e.g., graphical processing units (GPUs)) that are interconnected by a multi-tiered network. In such applications, switching systems capable of switching between numerous ports are utilized so that traffic can be forwarded between servers, GPUs, backbone network lines, etc. Such switching systems can include a large number of switches, and each switch typically is capable of switching between several ports. In data centers, server farms, AI systems, etc., multiple layers of switches are often utilized, where a first layer of switches interconnects a second layer of switches, and where the second layer of switches are connected to processors, servers, storage devices, etc.

Scaling up communication networks such as described above typically involves adding layers of switches. However, adding layers of switches typically increases latency, power, physical footprint, and cost, which may be problematic for some applications.

### SUMMARY

In an embodiment, a communication network comprises: a plurality of first switches, each first switch having i) a respective first integrated circuit (IC) switch chip having a plurality of network interfaces, ii) a respective plurality of downlink ports, and iii) a respective plurality of uplink ports; and a plurality of second switches, each second switch having i) a respective plurality of ports coupled to at least one uplink port of each of the first switches, ii) a respective second IC switch chip in a respective IC package, the second IC switch chip having a plurality of external network interfaces coupled to external interconnects of the IC package, and iii) a respective plurality of serializers/deserializers (SERDES) to communicatively couple the respective plurality of external network interfaces to the respective plurality of ports of the second switch. Each second IC switch chip further comprises: a plurality of internal network interfaces; a packet processor coupled to the plurality of internal network interfaces, the packet processor configured to forward packets amongst internal network interfaces of the plurality of internal network interfaces; and a plurality of multiplexer/demultiplexer circuitry, each multiplexer/demultiplexer circuitry coupled to i) a respective external network interface, and ii) a respective set of multiple internal network interfaces, each multiplexer/demultiplexer circuitry configured to i) demultiplex a first data stream received from the respective external network interface into a second data stream and a third data stream for transfer to the respective set of multiple internal network interfaces, and ii) multiplex a fourth data stream and a fifth data stream received via the respective set of multiple internal network interfaces into a sixth data stream for transfer to the respective external network interface.

In another embodiment, a method is for communicating in a communication network that includes i) a plurality of first network switches, and ii) a plurality of second network switches, each first network switch comprising i) a respective plurality of downlink ports, ii) a respective plurality of uplink ports, and iii) a respective one or more first integrated circuit (IC) switch chips communicatively coupled to the plurality of uplink ports and the plurality of downlink ports. Each second network switch comprises i) a respective plurality of ports coupled to at least one uplink port of each of the first network switches, and ii) a respective second IC switch chip communicatively coupled to the plurality of ports of the second switch. The method includes: receiving, at each first network switch among the plurality of first network switches, packets from network devices via the plurality of downlink ports; forwarding, by each first network switch, packets received via the plurality of downlink ports to the plurality of second network switches via a respective plurality of communication links between the first network switch and each second network switch in the plurality of second switches; at each second switch, transferring packets received from the plurality of first switches to external network interfaces of the second IC switch chip; in connection with each external network interface of each second IC switch chip, demultiplexing a respective first stream of packets received via the external network interface to multiple internal network interfaces of the second IC switch chip; at each second IC switch chip, forward packets received via the internal network interfaces of the second IC switch chip amongst the internal network interfaces of the second IC switch chip; in connection with each external network interface of each second IC switch chip, multiplexing at least a second stream of packets and a third stream of packets received via multiple internal network interfaces of the second IC switch chip to the external network interface; forwarding, by each second network switch, packets received from external network interfaces of the respective second IC switch chip to the plurality of first network switches via a respective plurality of communication links between the second network switch and each first network switch among the plurality of first network switches; and transmitting, by each first network switch among the plurality of first network switches, packets received from the plurality of second network switches to the plurality of network devices via the plurality of downlink ports.

### BRIEF DESCRIPTION OF THE DRAWINGS

FIG. 1A is a simplified diagram of an example communication network that includes a high number of computational processors interconnected by an example 2-tiered network having a plurality of high-radix network switches, according to an embodiment.

FIG. 1B is a simplified block diagram illustrating two communicatively coupled network switches of FIG. 1A, according to an embodiment.

FIG. 1C is a simplified diagram of a switch chip of some of the network switches of FIGS. 1A-B, according to an embodiment.

FIG. 1D is a simplified diagram of a switch chip of some of the network switches of FIGS. 1A-B, according to an embodiment.

FIG. 2A is a simplified diagram of another example communication network that includes a high number of computational processors interconnected by an example 2-tiered network having a plurality of high-radix network switches, according to another embodiment.

FIG. 2B is a simplified block diagram illustrating two communicatively coupled network switches of FIG. 2A, according to an embodiment.

FIG. 2C is a simplified block diagram illustrating two communicatively coupled network switches of FIG. 2A, according to another embodiment.

FIG. 2D is a simplified diagram of a switch chip of some of the network switches of FIGS. 2A and 2C, according to an embodiment.

FIG. 3 is a flow diagram of an example method for communicating in a communication network that includes i) a plurality of first network switches, and ii) a plurality of second network switches communicatively coupled to the first plurality of first network switches, according to an embodiment.

FIG. 4 is a simplified block diagram of example multiplexer circuitry that is included in communication networks such as illustrated in FIGS. 1A and 2A, according to an embodiment.

FIG. 5 is a simplified block diagram of example demultiplexer circuitry that is included in communication networks such as illustrated in FIGS. 1A and 2A, according to an embodiment.

FIG. 6 is a simplified block diagram of example multiplexer circuitry that is included in a switch of FIG. 2C, according to another embodiment.

FIG. 7A is a simplified block diagram of example multiplexer circuitry that is included in communication networks such as illustrated in FIGS. 1A and 2A, according to another embodiment.

FIG. 7B is a simplified diagram illustrating an example interleaving function performed by codeword interleaver circuitry of FIG. 7A, according to an embodiment.

FIG. 8A is a simplified block diagram of example demultiplexer circuitry that is included in communication networks such as illustrated in FIGS. 1A and 2A, according to another embodiment.

FIG. 8B is a simplified diagram illustrating an example deinterleaving function performed by codeword deinterleaver circuitry of FIG. 8A, according to an embodiment.

### DETAILED DESCRIPTION

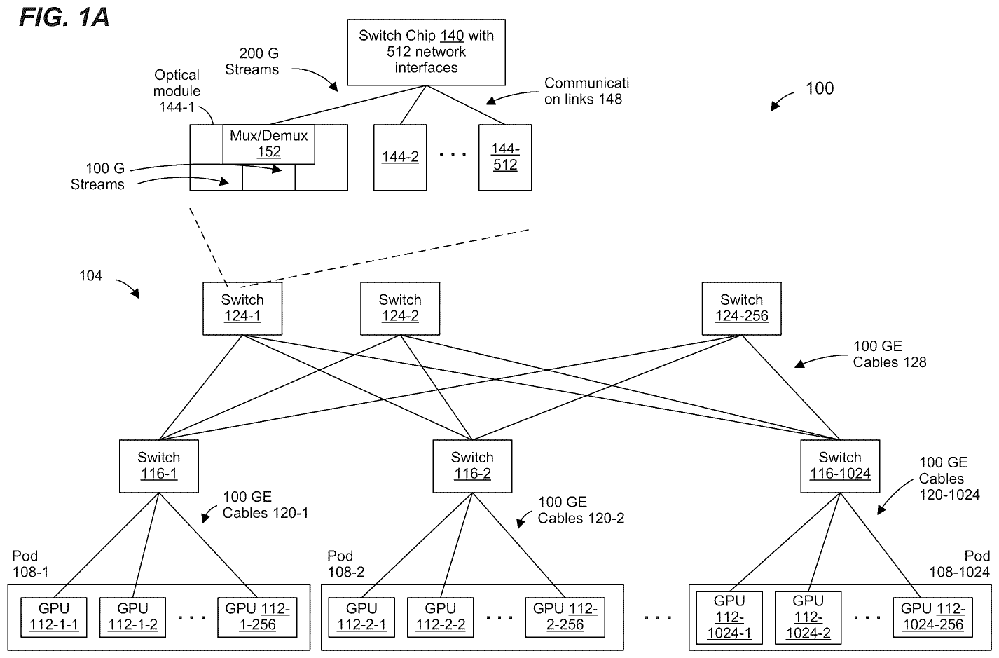

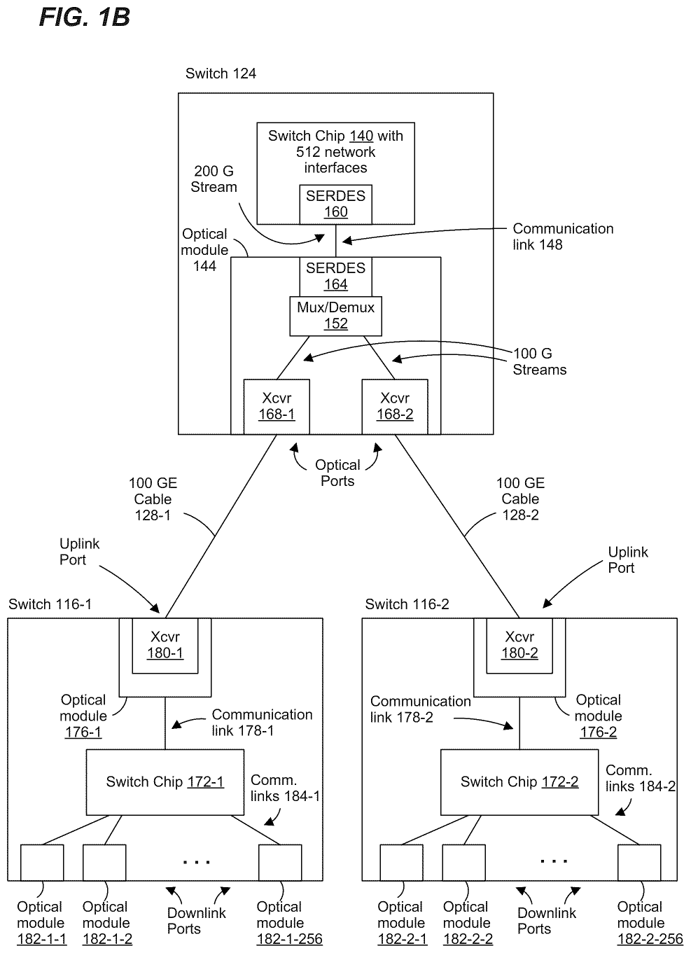

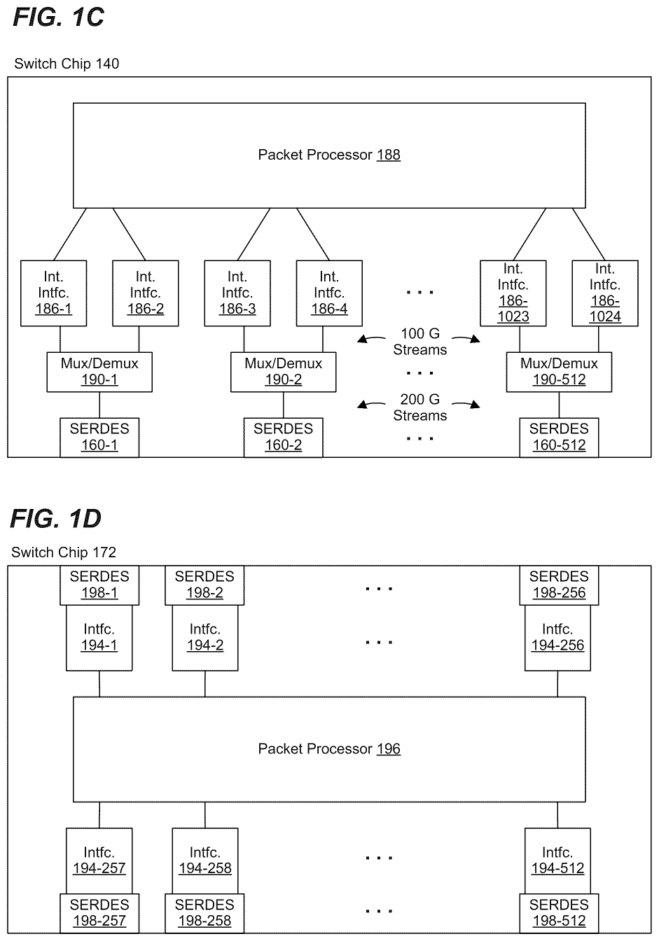

FIG. 1A is a simplified diagram of an example communication network 100 that includes a high number of computational processors interconnected by an example 2-tiered network 104 having a plurality of high-radix network switches, according to an embodiment. For example, the network 104 is coupled to a plurality of computational pods 108, each computational pod comprising a plurality of computational processors such as GPUs 112. In an embodiment, the number of computational pods 108 is 1024. In another embodiment, the number of computational pods 108 is a suitable number greater than or equal to 900. In another embodiment, the number of computational pods 108 is a suitable number greater than or equal to 1000. In another embodiment, the number of computational pods 108 is another suitable number.

In an embodiment, each of at least some of the computational processors 112 includes a graphics processing unit (GPU), and the computational processors 112 are sometimes referred to herein as GPUs 112 for ease of explanation. In other embodiments, each of at least some of the computational processors 112 includes a suitable processor other than a GPU, such as a central processing unit (CPU), a digital signal processor (DSP), a graph processor, etc. In some embodiments, at least some of the GPUs 112 are replaced by other suitable network devices such as memory devices, network switches, etc.

In an embodiment, the number of GPUs 112 in each computational pod 108 is 256. In another embodiment, the number of GPUs 112 in each computational pod 108 is a suitable number greater than or equal to 200. In another embodiment, the number of GPUs 112 in each computational pod 108 is a suitable number greater than or equal to 250. In another embodiment, the number of GPUs 112 in each computational pod 108 is another suitable number. In an embodiment, each computational pod 108 includes a same number of GPUs 112. In another embodiment, at least some computational pods 108 include different numbers of GPUs 112.

In an embodiment, the communication network 100 includes 262,144 GPUs 112 interconnected by the network 104. In another embodiment, the communication network 100 includes at least 200,000 GPUs 112 interconnected by the network 104. In another embodiment, the communication network 100 includes at least 250,000 GPUs 112 interconnected by the network 104. In other embodiments, the communication network 100 includes another suitable number of GPUs 112 interconnected by the network 104.

Each computational pod 108 is communicatively coupled to a respective network switch 116 of the network 104. For example, each GPU 112 of the computational pod 108 is communicatively coupled to the respective network switch 116 via a suitable cable 120 such as an electrical cable, an optical cable, etc. In an embodiment, each GPU 112 includes (or is coupled to) a port (not shown; e.g., an electrical port, an optical port, etc.) that is configured to couple to the cable 120 and to communicate at data rates of at least 100 gigabits per second (Gbps). The port of the GPU 112 is communicatively coupled to the network switch 116 via the cable 120 that is configured for communications at data rates of at least 100 Gbps. In an embodiment, the cables 120 are rated for 100 Gbps Ethernet (GE). In another embodiment, the cables 120 are rated for data rates higher than provided by 100 GE.

In an embodiment, each network switch 116 includes a plurality of ports (sometimes referred to herein as “downlink ports”; not shown; e.g., electrical ports, optical ports, etc.) to which the communication cables 120 are connected. Each of at least some of the downlink ports is configured to communicate at data rates of at least 100 Gbps. In an embodiment, the network switch 116 includes a number of downlink ports that is equal to or greater than the number of GPUs 256 in the computational pod 108. In an embodiment, the number of downlink ports of each network switch 116 is at least 256. In another embodiment, the number of downlink ports of each network switch 116 is a suitable number greater than or equal to 200. In another embodiment, the number of downlink ports of each network switch 116 is a suitable number greater than or equal to 250. In another embodiment, the number of downlink ports of each network switch 116 is another suitable number. In an embodiment, each network switch 116 includes a same number of downlink ports. In another embodiment, at least some network switches 116 include different numbers of downlink ports.

Each network switch 116 is communicatively coupled to a plurality of network switches 124 by a plurality of communication cables 128 (e.g., electrical cables, optical cables, etc.). In an embodiment, the cables 128 are rated for 100 GE. In another embodiment, the cables 128 are rated for data rates higher than provided by 100 GE. In an embodiment, each network switch 116 includes a plurality of ports (sometimes referred to herein as “uplink ports”; not shown; e.g., electrical ports, optical ports, etc.) to which the communication cables 128 are connected. Each of at least some of the uplink ports is configured to communicate at data rates of at least 100 Gbps.

Each of at least some of the network switches 124 is communicatively coupled to the plurality of network switches 116. In an embodiment, each network switch 124 includes a plurality of ports (not shown; e.g., electrical ports, optical ports, etc.) to which the communication cables 128 are connected. Each of at least some of the ports is configured to communicate at data rates of at least 100 Gbps. For each of at least some of the network switches 124, a number of ports is at least the same as the number of network switches 116. Thus, in the example illustrated in FIG. 1A in which there are 1024 network switches 116, each of at least some of the network switches includes at least 1024 ports. In another embodiment, the number of ports of each network switch 124 is a suitable number greater than or equal to 1000. In another embodiment, the number of ports of each network switch 124 is a suitable number greater than or equal to 900. In another embodiment, the number of ports of each network switch 124 is another suitable number. In an embodiment, each network switch 124 includes a same number of ports. In another embodiment, at least some network switches 124 include different numbers of ports.

Each network switch 124 include a switching integrated circuit (IC) 140, sometimes referred to herein as a “switch chip.” The switch chip 140 includes a plurality of internal network interfaces (not shown) communicatively coupled to the ports of the network switch 124. The switch chip 140 also includes other components (not shown) such as a memory to store packet data, a packet processor to analyze at least packet header data of packets received via the internal network interfaces to determine internal network interfaces via which the packet are to be forwarded, etc.

The switch chip 140 is included within in a suitable chip package having suitable external interconnect structures for inputting and outputting signals to/from the switch chip 140, such as a ball grid array (BGA), a pin grid array (PGA), etc.

As discussed above, each of at least some of the network switches 124 includes at least 1000 ports, in some embodiments, which are communicatively coupled to the switch chip 140. With many IC fabrication and/or chip packaging technologies, it is difficult to produce, in a commercially viable manner, a chip package having a switch IC with over 1000 high speed external connections. For example, a BGA chip package having a switch IC with over 1000 network interfaces operating would require many more than 1000 balls for just the network interfaces alone, and the high speed nature of the network interfaces would require a significant number of additional balls dedicated to ground and power connections.

To significantly reduce the number of external connections required on the switch chip 140, the switch chip 140 includes one external network interface for each of at least some sets of multiple ports, where the one external network interface is connected to an external interconnect of the IC package, which transmits/receives packet data corresponding to the set of multiple ports. For example, transmit packet data corresponding to the set of multiple ports is multiplexed within a combined transmit signal, and receive packet data corresponding to the set of multiple ports is multiplexed within a combined receive signal, in an embodiment. In the example of FIG. 1A in which each network switch 124 includes 1024 ports, the switch chip 140 includes 512 external network interfaces, where each external network interface corresponds to a respective pair of ports.

On the other hand, the switch chip 140 includes at least as many internal network interfaces as the number of ports of the network switch 124, and the internal network interfaces are communicatively coupled to the external network interfaces via multiplexer/demultiplexer circuitry (not shown), in some embodiments. The packet processor (not shown) is configured to forward packets received via the internal network interfaces amongst the internal network interfaces.

The network switch 124 includes a plurality of port modules 144 communicatively coupled to the external network interfaces of the switch chip 140 via respective communication links 148. The port modules 144 are optical modules 144, in an embodiment, and FIG. 1A illustrates optical modules 144. In other embodiments, the port modules 144 include electrical port modules.

Each of at least some of the communication links 148 operates at a data rate that is at least double a data rate at which the ports 144 operate. For example, in an embodiment in which ports 144 operate at a data rate of 100 Gbps, the communication links 148 operate at a data rate of at least 200 Gbps. Each of at least some of the port modules 144 corresponds to a respective pair of ports (e.g., electrical ports, optical ports, etc.), and each of at least some of the communication links 148 transmit/receive data corresponding to the pair of ports.

Each port module 144 includes multiplexer/demultiplexer circuitry (mux/demux) 152 that is configured to i) multiplex data received via the pair of ports (each at 100 Gbps, for example) into a combined receive stream for transmission to the switch chip 140 via the communication link 148 (e.g., at 200 Gbps), and ii) demultiplex a combined transmit stream received from the switch chip 140 via the communication link 148 (e.g., at 200 Gbps) into a pair of transmit streams to be transmitted by the pair of ports (e.g., at 100 Gbps).

FIG. 1B is a simplified block diagram of one of the network switches 124 communicatively coupled to two of the network switches 116 of FIG. 1A, according to an embodiment. FIG. 1B is discussed below with reference to FIG. 1A.

The switch chip 140 includes a plurality of serializers/deserializers (SERDES) 160, each corresponding to a respective external network interface of the switch chip 140. Each SERDES 160 is communicatively coupled to a pair of optical ports of the network switch 124, according to an embodiment. FIG. 1B illustrates only one SERDES 160 for ease of explanation, but the switch chip 140 includes a plurality of SERDES 160, as discussed above. The SERDES 160 is configured to operate at a data rate that is at least double a data rate at which the ports 144 operate. For example, in an embodiment in which ports 144 operate at a data rate of 100 Gbps, the SERDES 160 is configured to operate at a data rate of at least 200 Gbps.

The SERDES 160 is communicatively coupled to a respective optical port module 144 via a respective communication link 148. FIG. 1B illustrates only one optical port module 144 for ease of explanation, but the network switch 124 includes a plurality of optical port modules 144, as discussed above. The optical port module 144 includes a SERDES 164 coupled to the communication link 148. The SERDES 164 is configured to operate at the data rate that is at least double the data rate at which the optical ports operate. For example, in an embodiment in which optical ports operate at a data rate of 100 Gbps, the SERDES 164 is configured to operate at a data rate of at least 200 Gbps. The SERDES 164 is coupled to the mux/demux 152.

The optical port module 144 further includes respective optical transceivers 168 for respective optical ports. Each optical transceiver 168 is configured to i) receive an optical signal via the respective cable 128 (a 100 Gbps optical signal, for example), ii) convert the optical signal into an electrical signal (a 100 Gbps electrical signal, for example), and iii) provide the electrical signal to the mux/demux 152. Each optical transceiver 168 is also configured to i) receive an electrical signal from the mux/demux 152 (a 100 Gbps electrical signal, for example), ii) convert the electrical signal into an optical signal (a 100 Gbps optical signal, for example), and iii) provide the optical signal to the respective cable 128.

Each network switch 116 includes a respective switch chip 172 coupled to a plurality of optical port modules 176. FIG. 1B illustrates only one optical port module 176 in each network switch 116 for case of explanation, but each network switch 116 includes a plurality of optical port modules 176. The optical port module 176 is communicatively coupled to the switch chip 172 via a communication link 178. The communication links 178 operates at a data rate that is at least as high as the data rate of the optical ports. For example, in an embodiment in which optical ports operate at a data rate of 100 Gbps, the communication link 178 operates at a data rate of at least 100 Gbps.

The optical port module 176 includes an optical transceiver 180 corresponding to an optical port of the network switch 116. Each optical transceiver 180 is configured to i) receive an optical signal via the cable 128 (a 100 Gbps optical signal, for example), ii) convert the optical signal into an electrical signal (a 100 Gbps electrical signal, for example), and iii) provide the electrical signal to the switch chip 172. Each optical transceiver 180 is also configured to i) receive an electrical signal from the switch chip 172 (a 100 Gbps electrical signal, for example), ii) convert the electrical signal into an optical signal (a 100 Gbps optical signal, for example), and iii) provide the optical signal to the cable 128.

The network switch 116 also includes a plurality of optical port modules 182 corresponding to respective downlink ports of the network switch 116. The optical port modules 182 have a structure the same as or similar to the optical port modules 176, in an embodiment. Each optical port module 182 is configured to operate at a rate of at least 100 Gbps, in an embodiment.

The optical port modules 182 are communicatively coupled to the switch chip 172 via communication links 184. Each communication link 184 operates at a data rate that is at least as high as the data rate of the optical port modules 182. For example, in an embodiment in which optical ports operate at a data rate of 100 Gbps, each communication link 184 operates at a data rate of at least 100 Gbps.

In other embodiments, the optical port modules 144, 176 are replaced with electrical port modules that include electrical transceivers, and the cables 128 are electrical cables.

FIG. 1C is a simplified diagram of the switch chip 140 of the network switch 124 of FIGS. 1A-B, according to an embodiment. The switch chip 140 includes a plurality of internal network interfaces 186. In the example embodiment of FIG. 1C, the switch chip 140 includes 1024 internal network interfaces 186. In an embodiment, the switch chip 140 includes at least as many internal network interfaces 186 as there are network switches 116. In an embodiment, the switch chip 140 includes at least 1000 internal network interfaces 186. In another embodiment, the switch chip 140 includes at least 950 internal network interfaces 186. In another embodiment, the switch chip 140 includes at least 900 internal network interfaces 186.

The switch chip 140 also includes a packet processor 188 coupled to the plurality of internal network interfaces 186. The packet processor 188 is configured to forward packets between the internal network interfaces 186. For example, the packet processor 188 is configured to analyze at least packet header data of packets received via the internal network interfaces 186 to determine internal network interfaces 186 via which the packets are to be forwarded, etc.

The packet processor 188 has suitable processing power to operate in an environment in which the internal network interfaces 186 are communicatively coupled to a large number of switches 116 via at least 100 Gbps links, according to an embodiment.

The switch chip 140 includes other suitable components (not shown) such as a memory to store packet data, memory management circuitry, etc.

To significantly reduce the number of external connections required on the switch chip 140, the switch chip 140 includes one SERDES for each of at least some sets of multiple internal network interfaces 186, where the one SERDES transmits/receives packet data corresponding to the set of multiple internal network interfaces 186. For example, transmit packet data corresponding to the set of multiple internal network interfaces 186 is multiplexed within a combined transmit signal, and receive packet data corresponding to the set of multiple internal network interfaces 186 is multiplexed within a combined receive signal, in an embodiment. In the example of FIG. 1A in which each network switch 124 includes 1024 ports, the switch chip 140 includes 512 SERDES 160, where each SERDES 160 corresponds to a respective pair of internal network interfaces 186.

As discussed above, each SERDES 160 is coupled to a corresponding port module 144.

The switch chip 140 also includes a plurality of muxes/demuxes 190 coupled to the plurality of SERDES 160. Each mux/demux 190 is configured to i) multiplex data received via the pair of internal network interfaces 186 (each at 100 Gbps, for example) into a combined transmit stream for transmission to the corresponding port module 144 via the communication link 148 (e.g., at 200 Gbps), and ii) demultiplex a combined receive stream received from the port module 144 via the communication link 148 (e.g., at 200 Gbps) into a pair of receive streams to be transferred to the pair of internal network interfaces 186 (e.g., at 100 Gbps).

Each SERDES 160, mux/demux 190 pair corresponds to an external network interface of the IC switch chip 140, in an embodiment. Each SERDES 160 is coupled to an external interconnect (e.g., a solder ball, a pin, etc.) of an IC package in which the switch chip 140 is packaged, according to an embodiment.

FIG. 1D is a simplified diagram of the switch chip 172 of the network switch 116 of FIGS. 1A-B, according to an embodiment. The switch chip 172 includes a plurality of network interfaces 194. In the example embodiment of FIG. 1D, the switch chip 172 includes 512 network interfaces 194. In an embodiment, the switch chip 172 includes at least as many network interfaces 194 as a sum of a) the number of GPUs 112 to which the switch chip 172 is communicatively coupled, and b) the number of network switches 124 to which the switch chip 172 is communicatively coupled. In an embodiment, the switch chip 140 includes at least 500 network interfaces 194. In another embodiment, the switch chip 172 includes at least 475 network interfaces 194. In another embodiment, the switch chip 140 includes at least 450 network interfaces 194.

The switch chip 172 also includes a packet processor 196 coupled to the plurality of network interfaces 194. The packet processor 196 is configured to forward packets between the network interfaces 194. For example, the packet processor 196 is configured to analyze at least packet header data of packets received via the network interfaces 194 to determine network interfaces 194 via which the packets are to be forwarded, etc.

The packet processor 196 has suitable processing power to operate in an environment in which the network interfaces 194 are communicatively coupled to a large number of GPUs 112 and a large number of switches 116 via at least 100 Gbps links, according to an embodiment.

The switch chip 196 includes other suitable components (not shown) such as a memory to store packet data, memory management circuitry, etc.

Referring now to FIGS. 1B and 1D, each network interface 194 includes or is coupled to a SERDES 198. Each SERDES 198 is configured to operate at a data rate of 100 Gbps. The SERDES 198-1 through 198-256 correspond to uplink ports of the switch 116 and are coupled to respective port modules 176 via respective communication links 180. The SERDES 198-257 through 198-512 correspond to downlink ports of the switch 116 and are coupled to respective port modules 176 via respective communication links 178.

Each SERDES 198 is coupled to an external interconnect (e.g., a solder ball, a pin, etc.) of an IC package in which the switch chip 172 is packaged, according to an embodiment.

Referring again to FIG. 1A, the network 104 provides low latency communication between GPUs 112 amongst a very large number of GPUs (e.g., at least 200,000 GPUs 112). For instance, each GPU 112 in a first computational pod 108 is communicatively connected to another GPU 112 in a second computational pod 108 via a large number of alternate paths, where each path traverses at most three network switches 116, 124, in an embodiment.

In an embodiment in which the communication network 100 includes 1024 network switches 116 and 256 network switches 124, the interconnections between the network switches 116 and the network switches 124 includes 262,144 cables 128.

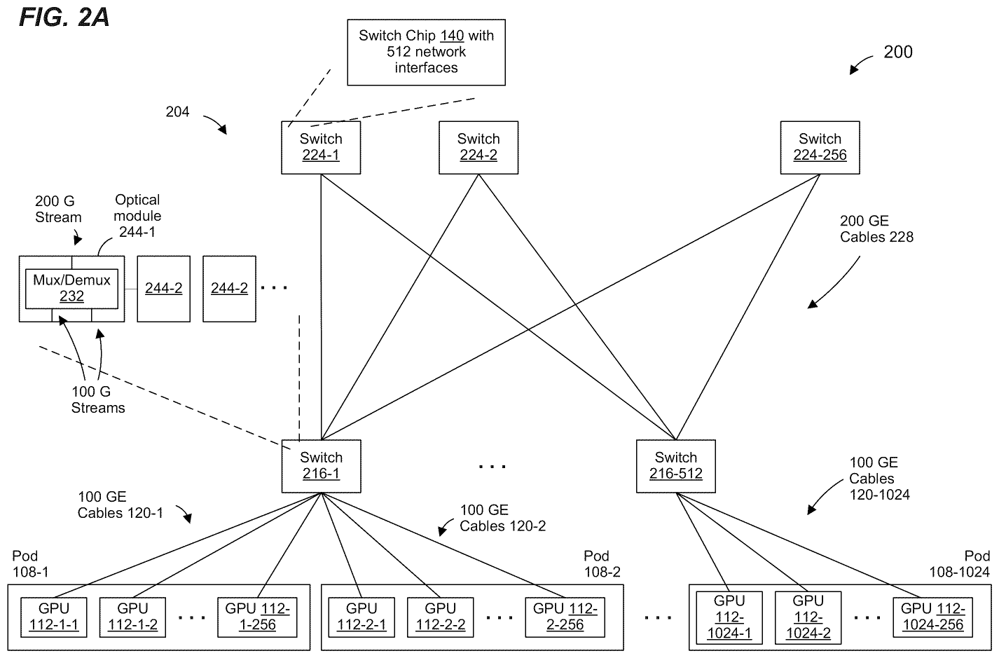

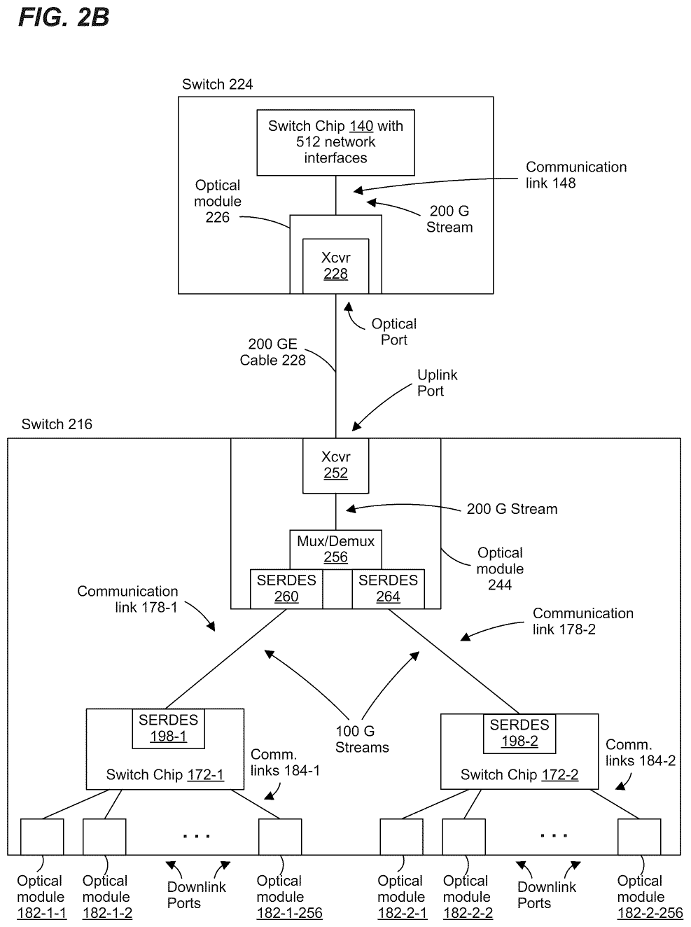

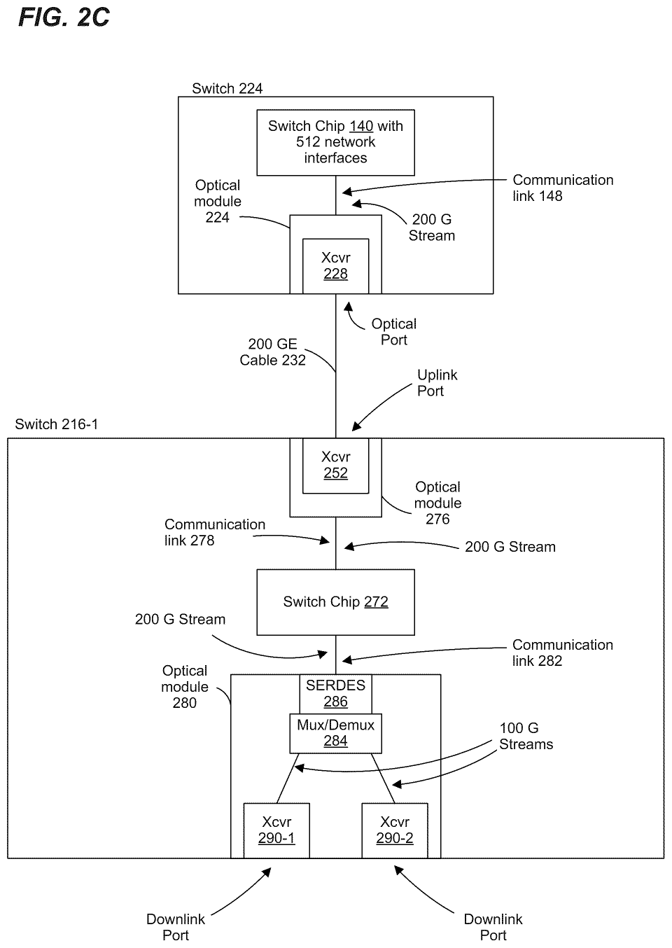

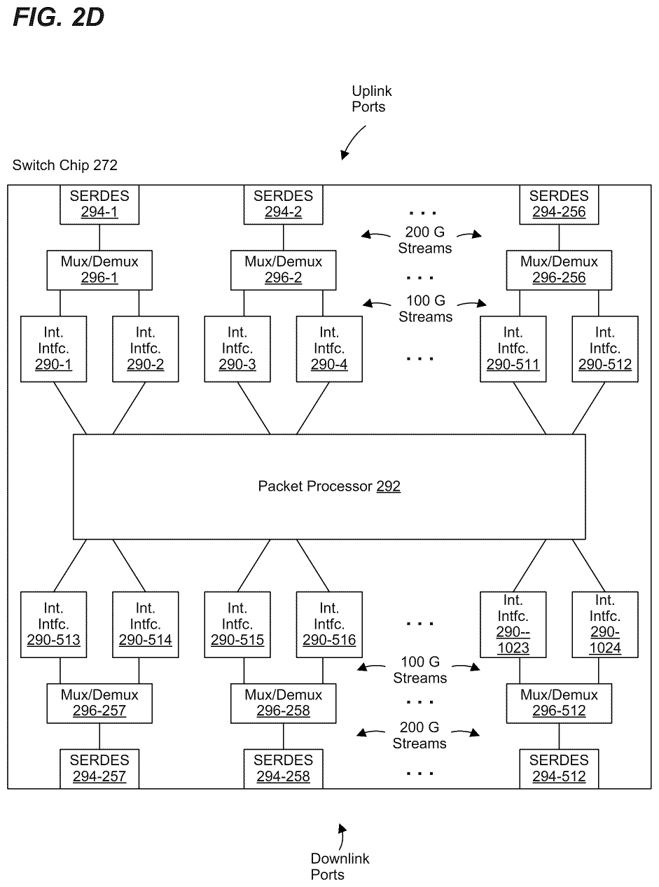

FIG. 2A is a simplified diagram of another example communication network 200 that includes a high number of computational processors interconnected by an example 2-tiered network 204 having a plurality of high-radix network switches, according to another embodiment. The communication network 200 includes some components of the example communication network 100 of FIG. 1A, and like-numbered elements are not described again in detail for brevity.

The network 204 is coupled to the plurality of computational pods 108. In an embodiment, the number of computational pods 108 is 1024. In another embodiment, the number of computational pods 108 is a suitable number greater than or equal to 900. In another embodiment, the number of computational pods 108 is a suitable number greater than or equal to 1000. In another embodiment, the number of computational pods 108 is another suitable number.

Each pair of computational pods 108 is communicatively coupled to a respective network switch 216 of the network 204. For example, each GPU 112 of the pair of computational pods 108-1 is communicatively coupled to the respective network switch 216 via a suitable cable 120 such as an electrical cable, an optical cable, etc.

In an embodiment, each network switch 216 includes a plurality of ports (sometimes referred to herein as “downlink ports”; not shown; e.g., electrical ports, optical ports, etc.) to which the communication cables 120 are connected. Each of at least some of the downlink ports is configured to communicate at data rates of at least 100 Gbps. In an embodiment, the network switch 216 includes a number of downlink ports that is equal to or greater than the number of GPUs 112 in the pair of computational pods 108. In an embodiment, the number of downlink ports of each network switch 216 is at least 512. In another embodiment, the number of downlink ports of each network switch 216 is a suitable number greater than or equal to 400. In another embodiment, the number of downlink ports of each network switch 216 is a suitable number greater than or equal to 500. In another embodiment, the number of downlink ports of each network switch 216 is another suitable number. In an embodiment, each network switch 216 includes a same number of downlink ports. In another embodiment, at least some network switches 216 include different numbers of downlink ports.

Each network switch 216 is communicatively coupled to a plurality of network switches 224 by a plurality of communication cables 228 (e.g., electrical cables, optical cables, etc.). In an embodiment, the cables 228 are rated for 200 GE. In another embodiment, the cables 228 are rated for data rates higher than provided by 200 GE. In an embodiment, each network switch 216 includes a plurality of ports (sometimes referred to herein as “uplink ports”; not shown; e.g., electrical ports, optical ports, etc.) to which the communication cables 228 are connected. Each of at least some of the uplink ports is configured to communicate at data rates of at least 200 Gbps.

Each of at least some of the network switches 224 is communicatively coupled to the plurality of network switches 216. In an embodiment, each network switch 224 includes a plurality of ports (not shown; e.g., electrical ports, optical ports, etc.) to which the communication cables 228 are connected. Each of at least some of the ports is configured to communicate at data rates of at least 200 Gbps. For each of at least some of the network switches 224, a number of ports is at least the same as the number of network switches 216. Thus, in the example illustrated in FIG. 2A in which there are 512 network switches 216, each of at least some of the network switches 224 includes at least 512 ports. In another embodiment, the number of ports of each network switch 224 is a suitable number greater than or equal to 500. In another embodiment, the number of ports of each network switch 224 is a suitable number greater than or equal to 450. In another embodiment, the number of ports of each network switch 224 is another suitable number. In an embodiment, each network switch 224 includes a same number of ports. In another embodiment, at least some network switches 224 include different numbers of ports.

Each network switch 224 includes the switch chip 140 discussed above.

In an embodiment in which the communication network 200 includes 512 network switches 216 and 256 network switches 224, the interconnections between the network switches 216 and the network switches 224 includes 131,072 cables 228, which is significantly less than the number of cables 128 (262,144 cables) in the example communication network 100 of FIG. 1A (at least in some embodiments).

Each network switch 216 communicates with the network switches 224 via 200 Gbps streams, and communicates with the GPUs 112 via 100 Gbps streams, in an embodiment. Accordingly, each network switch 216 includes port modules 244, each having a respective mux/demux 256, according to an embodiment. The port modules 244 are optical modules 244, in an embodiment, and FIG. 2A illustrates optical modules 244. In other embodiments, the port modules 244 include electrical port modules.

Each mux/demux 256 is configured to i) multiplex data a first pair of streams at a first data rate (100 Gbps, for example) into a first combined stream at a higher second data rate (e.g., at 200 Gbps), and ii) demultiplex a second combined transmit at the higher second data rate (e.g., at 200 Gbps) into a second pair of streams at the first data rate (e.g., at 100 Gbps).

FIG. 2B is a simplified block diagram of one of the network switches 224 communicatively coupled to one of the network switches 216 of FIG. 2A, according to an embodiment. FIG. 2B is discussed below with reference to FIG. 2A.

Similar to the network switches 124 of FIGS. 1A-B, each network switch 224 includes the switch chip 140. The network switch 224 includes a plurality of port modules 226 communicatively coupled to the external network interfaces of the switch chip 140 via respective communication links 148. Each of at least some of the communication links 148 operates at a data rate that is at least the same a data rate at which the optical ports of the network switch 224 operate. For example, in an embodiment in which optical ports operate at a data rate of 200 Gbps, the communication links 148 operate at a data rate of at least 200 Gbps. Each of at least some of the ports modules 226 corresponds to a respective port, and each of at least some of the communication links 148 transmit/receive data corresponding to the optical port.

As discussed above with reference to FIGS. 1B-C, the switch chip 140 includes the plurality of SERDES 160 (not shown in FIG. 2B), each corresponding to a respective internal network interface 186 of the switch chip 140. Each SERDES 160 is communicatively coupled to a respective port module 226 via a respective communication link 148, according to an embodiment. FIG. 2B illustrates only one port module 226 for case of explanation, but the network switch 224 includes a plurality of port modules 226, as discussed above.

The port module 226 includes an optical transceiver 228 for the corresponding optical port. The optical transceiver 228 is configured to i) receive an optical signal via the respective cable 228 (a 200 Gbps optical signal, for example), ii) convert the optical signal into an electrical signal (a 200 Gbps electrical signal, for example), and iii) provide the electrical signal to the switch chip 140 via the communication link 148. The optical transceiver 228 is also configured to i) receive an electrical signal via the communication link 148 (a 200 Gbps electrical signal, for example), ii) convert the electrical signal into an optical signal (a 200 Gbps optical signal, for example), and iii) provide the optical signal to the cable 228.

In some embodiments, the port module 226 includes a SERDES (not shown) that is configured to interface the optical transceiver 228 with the communication link 148.

Each network switch 216 includes a plurality of the switch chips 172. As discussed above with reference to FIG. 1D, each switch chip 172 includes a plurality of network interfaces 194 communicatively coupled to respective uplink ports and respective downlink ports of the network switch 216. Each switch chip 172 also includes other components (not shown in FIG. 2B) such as a memory to store packet data, a packet processor to analyze at least packet header data of packets received via the network interfaces to determine network interfaces via which the packet are to be forwarded, etc. The network interfaces 194 of the switch chips 172 are configured to operate at a data rate that is at least the date rate at which the downlink ports operate. In an embodiment, at least some of the network interfaces 194 of the switch chips 172 are configured to operate at a date rate of at least 100 Gbps.

In an embodiment, each network interface 194 of the switch chip 172 includes, or is coupled to, a SERDES 198 configured to operate at a data rate that is at least as high as the data rate of downlink ports of the network switch 216. For example, in an embodiment in which downlink ports operate at a data rate of 100 Gbps, the SERDES 198 operate at a data rate of at least 100 Gbps.

Some of the SERDES 198 correspond to downlink ports of the switch 216 and are communicatively coupled to port modules 182 that correspond to the downlink ports. The port modules 182 have a structure similar to the port module 226 of the network switch 224, but operate at a lower data rate that corresponds to the downlink ports, in an embodiment. For example, the port modules 182 corresponding to the downlink ports operate at a data rate of at least 100 Gbps, in an embodiment.

The network switch 216 includes a plurality of optical port modules 244 corresponding to uplink ports of the network switch 216. FIG. 2B illustrates only one optical port module 244 in each network switch 216 for case of explanation, but each network switch 216 includes a plurality of optical port modules 244. The optical port module 244 is communicatively coupled to the plurality of switch chips 240 via respective communication links 178. The communication links 178 operates at a data rate that is at least as high as the data rate of downlink ports of the network switch 216. For example, in an embodiment in which downlink ports operate at a data rate of 100 Gbps, the communication links 178 operate at a data rate of at least 100 Gbps. In an embodiment, each communication link 178 is coupled to a respective SERDES in a respective switch chip 240, in an embodiment.

The optical port module 244 includes an optical transceiver 252 corresponding to an uplink port of the network switch 216. Each optical transceiver 252 is configured to i) receive an optical signal via the cable 228 (a 200 Gbps optical signal, for example), ii) convert the optical signal into an electrical signal (a 200 Gbps electrical signal, for example), and iii) provide the electrical signal to a mux/demux 256. Each optical transceiver 244 is also configured to i) receive an electrical signal from the mux/demux 256 (a 200 Gbps electrical signal, for example), ii) convert the electrical signal into an optical signal (a 200 Gbps optical signal, for example), and iii) provide the optical signal to the cable 228.

The mux/demux 256 is configured to i) multiplex a first pair of data streams (each at 100 Gbps, for example) received from one or both of the switch chips 240 into a first combined stream to be transmitted by the optical ports (e.g., at 200 Gbps), and ii) demultiplex a second combined stream received from the optical port (e.g., at 200 Gbps) into a second pair of streams to be transmitted to the one or both of the switch chips 240 (e.g., at 100 Gbps).

Each optical port module 244 also includes a plurality of SERDES 260, 264. The SERDES 260, 264 are configured to operate at a data rate that is at least a data rate at which the downlink ports of the network switch 216 operate. For example, in an embodiment in which downlink ports operate at a data rate of 100 Gbps, the SERDES 260, 264 are configured to operate at a data rate of at least 100 Gbps.

Each switch chip 172 includes a plurality of SERDES 198, each corresponding to a respective network interface of the switch chip 172. Each SERDES 198 is communicatively coupled to an optical module 244, according to an embodiment. FIG. 2B illustrates only one SERDES 198 in each switch chip 240 for case of explanation, but each switch chip 172 includes a plurality of SERDES 198 corresponding to multiple uplink ports, as discussed above. The SERDES 198 is configured to operate at a data rate that is at least a data rate at which the downlink ports operate. For example, in an embodiment in which downlink ports operate at a data rate of 100 Gbps, the SERDES 198 are configured to operate at a data rate of at least 100 Gbps.

Although the SERDES 260, 264 are illustrated in FIG. 2B as being communicatively coupled to network interfaces of respective switch chips 172, in another embodiment both SERDES 260, 264 are communicatively coupled to network interfaces of one of the switch chips 172.

In an embodiment, the plurality of switch chips 172 of the network switch 216 are mounted on a single printed circuit board (PCB). In an embodiment, the plurality of switch chips 172 and at least some of the optical modules 244 are mounted on the single PCB.

Referring now to FIGS. 2A-B, the network 204 provides low latency communication between GPUs 112 amongst a very large number of GPUs (e.g., at least 200,000 GPUs 112). For instance, each GPU 112 in a first computational pod 108 is communicatively connected to another GPU 112 in a second computational pod 108 via a large number of alternate paths, where each path traverses at most three network switches 216, 224, in an embodiment.

Additionally, as compared with the network 104 of FIG. 1A, the network switching system 204 uses significantly less cables. For example, there are 131,072 cables 228 (in an embodiment) between the network switches 216 and the network switches 224 as compared to 262,144 cables 128 (in an embodiment) between the network switches 116 and the network switches 124. Also, as compared with the network 104 of FIG. 1A, the network 204 uses significantly less switch devices. For example, there are 512 switch devices 216 (in an embodiment) as compared to 1024 switch devices 116 (in an embodiment).

In other embodiments, the optical port modules 182, 226, 244 are replaced with electrical port modules that include electrical transceivers, and the cables 128 are electrical cables.

In another embodiment, the optical module 226 of the switch 224 includes a mux/demux (not shown) that is configured to demultiplex a first combined stream received from the switch chip 140 via the communication link 148 (e.g., at 200 Gbps) into a first pair of streams (each at e.g., 100 Gbps) to be transmitted by the optical transceiver 228 on respective optical wavelengths via the cable 228. Additionally, the mux/demux (not shown) of the optical module 226 is configured to multiplex a second pair of streams (each at e.g., 100 Gbps) to generate a second combined stream for transmission to the switch chip 140 via the communication link 148, the second pair of streams having been received by the optical transceiver 228 on respective optical wavelengths via the cable 228. Additionally, the optical transceiver 252 of the optical module 244 of the switch 216 is configured to provide a first pair of streams (each at e.g., 100 Gbps) received on respective optical wavelengths via the cable 228 to the SERDES 260, 264. Additionally, the SERDES 260, 264 provide a second pair of streams (each at e.g., 100 Gbps) to the optical transceiver 252 for transmission on respective optical wavelengths via the cable 228. In some such embodiments, the mux/demux 256 is omitted.

FIG. 2C is a simplified block diagram of one of the network switches 224 communicatively coupled to one of the network switches 216 of FIG. 2A, according to another embodiment. FIG. 2C is discussed below with reference to FIGS. 2A-B. The diagram of FIG. 2C is similar to the diagram of FIG. 2B, and like-numbered elements are not discussed again in detail for brevity.

Each network switch 216 includes a respective switch chip 272 coupled to a plurality of optical port modules 276 that correspond to respective uplink ports of the network switch 216. FIG. 2C illustrates only one optical port module 276 for ease of explanation, but each network switch 216 includes a plurality of optical port modules 276. The optical port module 276 is communicatively coupled to the switch chip 272 via a communication link 278. The communication link 278 operates at a data rate that is at least as high as the data rate of uplink ports of the network switch 216. For example, in an embodiment in which uplink ports operate at a data rate of 200 Gbps, the communication link 278 operates at a data rate of at least 200 Gbps.

Each switch chip 272 includes a plurality of internal network interfaces (not shown in FIG. 2C) communicatively coupled to respective uplink ports and respective pairs of downlink ports of the network switch 216. Each switch chip 272 (discussed below in more detail with reference to FIG. 2D) also includes other components (not shown) such as a memory to store packet data, a packet processor to analyze at least packet header data of packets received via the internal network interfaces to determine internal network interfaces via which the packet are to be forwarded, etc.

The switch chip 272 is also coupled to a plurality of optical port modules 280 that correspond to respective downlink ports of the network switch 216. Some of the network interfaces (not shown) of the switch chip 272 are communicatively coupled to the optical port modules 280.

FIG. 2C illustrates only one optical port module 280 for ease of explanation, but each network switch 216 includes a plurality of optical port modules 280. The optical port module 280 is communicatively coupled to the switch chip 272 via a communication link 282. The communication link 282 operates at a data rate that is at least as high as twice the data rate of downlink ports of the network switch 216. For example, in an embodiment in which downlink ports operate at a data rate of 100 Gbps, the communication link 282 operates at a data rate of at least 200 Gbps.

Each optical port module 280 includes a mux/demux 284 that is configured to i) multiplex data received via the pair of optical ports (each at 100 Gbps, for example) into a combined receive stream for transmission to the switch chip 272 via the communication link 282 (e.g., at 200 Gbps), and ii) demultiplex a combined transmit stream received from the switch chip 272 via the communication link 282 (e.g., at 200 Gbps) into a pair of transmit streams to be transmitted by the pair of optical ports (e.g., at 100 Gbps).

The optical port module 280 also includes a SERDES 286 coupled to the communication link 282. The SERDES 286 is configured to operate at the data rate that is at least double the data rate at which the downlink ports operate. For example, in an embodiment in which downlink ports operate at a data rate of 100 Gbps, the SERDES 286 is configured to operate at a data rate of at least 200 Gbps. The SERDES 286 is coupled to the mux/demux 284.

The optical port module 280 further includes respective optical transceivers 288 for respective downlink ports. Each optical transceiver 288 is configured to i) receive an optical signal via the respective cable 120 (a 100 Gbps optical signal, for example), ii) convert the optical signal into an electrical signal (a 100 Gbps electrical signal, for example), and iii) provide the electrical signal to the mux/demux 284. Each optical transceiver 288 is also configured to i) receive an electrical signal from the mux/demux 284 (a 100 Gbps electrical signal, for example), ii) convert the electrical signal into an optical signal (a 100 Gbps optical signal, for example), and iii) provide the optical signal to the respective cable 120.

FIG. 2D is a simplified diagram of the switch chip 272 of the network switch 216 of FIGS. 2A and 2C, according to an embodiment. The switch chip 272 includes a plurality of internal network interfaces 290. In the example embodiment of FIG. 2D, the switch chip 272 includes 1024 internal network interfaces 290. In an embodiment, the switch chip 272 includes at least as many internal network interfaces 290 as a sum of a) two times the number of network switches 224, and b) the number of GPUs 112 in two pods 108. In an embodiment, the switch chip 272 includes at least 1000 internal network interfaces 290. In another embodiment, the switch chip 272 includes at least 950 internal network interfaces 290. In another embodiment, the switch chip 272 includes at least 900 internal network interfaces 290.

Each of at least some of the internal network interface 290 are configured to operate at a data rate that is at least the data rate at which uplink ports of the network switch 216 operate. For example, in an embodiment in which uplink ports operate at a data rate of 200 Gbps, at least some of the network interfaces 290 are configured to operate at a date rate of at least 200 Gbps.

The switch chip 272 also includes a packet processor 292 coupled to the plurality of internal network interfaces 290. The packet processor 292 is configured to forward packets between the internal network interfaces 290. For example, the packet processor 292 is configured to analyze at least packet header data of packets received via the internal network interfaces 290 to determine internal network interfaces 290 via which the packets are to be forwarded, etc.

The packet processor 292 has suitable processing power to operate in an environment in which the network interfaces 290 are communicatively coupled to i) a large number of switches 224 via at least 200 Gbps links, and ii) a large number of GPUs 112 via at least 100 Gbps links, according to an embodiment.

The switch chip 272 includes other suitable components (not shown) such as a memory to store packet data, memory management circuitry, etc.

To significantly reduce the number of external connections required on the switch chip 272, the switch chip 272 includes one SERDES 294 for each of at least some sets of multiple internal network interfaces 290, where the one SERDES 294 transmits/receives packet data corresponding to the set of multiple internal network interfaces 290. For example, transmit packet data corresponding to the set of multiple internal network interfaces 290 is multiplexed within a combined transmit signal, and receive packet data corresponding to the set of multiple internal network interfaces 290 is multiplexed within a combined receive signal, in an embodiment. In the example of FIGS. 2A and 2C in which each network switch 216 includes 768 ports, the switch chip 272 includes 512 SERDES 294, where each SERDES 294 corresponds to a respective pair of internal network interfaces 290.

Referring now to FIGS. 2C-D, each of SERDES 294-1 through 294-256 corresponds to a respective uplink port and is coupled to a corresponding port module 276. Each of SERDES 292-257 through 294-512 corresponds to a corresponding pair of downlink ports and is coupled to a corresponding port module 280. In an embodiment, each SERDES 294 is configured to operate at a data rate that is at least as high as the data rate of uplink ports of the network switch 216. For example, in an embodiment in which uplink ports operate at a data rate of 200 Gbps, the SERDES 294 operate at a data rate of at least 200 Gbps.

The switch chip 272 also includes a plurality of muxes/demuxes 296 coupled to the plurality of SERDES 294. Each mux/demux 296 is configured to i) multiplex data received via the pair of internal network interfaces 290 (each at 100 Gbps, for example) into a combined transmit stream for transmission to the corresponding port module 276, 280 via the communication link 180, 282 (e.g., at 200 Gbps), and ii) demultiplex a combined receive stream received from the port module 276, 280 via the communication link 180, 282 (e.g., at 200 Gbps) into a pair of receive streams to be transferred to the pair of internal network interfaces 290 (e.g., at 100 Gbps).

Each SERDES 294, mux/demux 296 pair corresponds to an external network interface of the IC switch chip 272, in an embodiment. Each SERDES 294 is coupled to an external interconnect (e.g., a solder ball, a pin, etc.) of an IC package in which the switch chip 272 is packaged, according to an embodiment.

Referring now to FIGS. 2A and C, the network 204 provides low latency communication between GPUs 112 amongst a very large number of GPUs (e.g., at least 200,000 GPUs 112). For instance, each GPU 112 in a first computational pod 108 is communicatively connected to another GPU 112 in a second computational pod 108 via a large number of alternate paths, where each path traverses at most three network switches 216, 224, in an embodiment.

Additionally, as compared with the network 104 of FIG. 1A, the network 204 uses significantly less cables. For example, there are 131,072 cables 228 (in an embodiment) between the network switches 216 and the network switches 224 as compared to 262,144 cables 128 (in an embodiment) between the network switches 116 and the network switches 124. Also, as compared with the network 104 of FIG. 1A, the network 204 uses significantly less switch devices. For example, there are 512 switch devices 216 (in an embodiment) as compared to 1024 switch devices 116 (in an embodiment).

Additionally, each network switch 216 of the FIG. 2C includes only one switch chip 272 (as compared to multiple switch chips 240 of FIG. 2B), and thus a network using the network switch 216 of FIG. 2C has significantly less switch chips 272 as compared with the number of switch chips 240 used when a network uses the network switch 216 of FIG. 2B.

In other embodiments, the optical port modules 276, 280 are replaced with electrical port modules that include electrical transceivers, and the cables 232 are electrical cables.

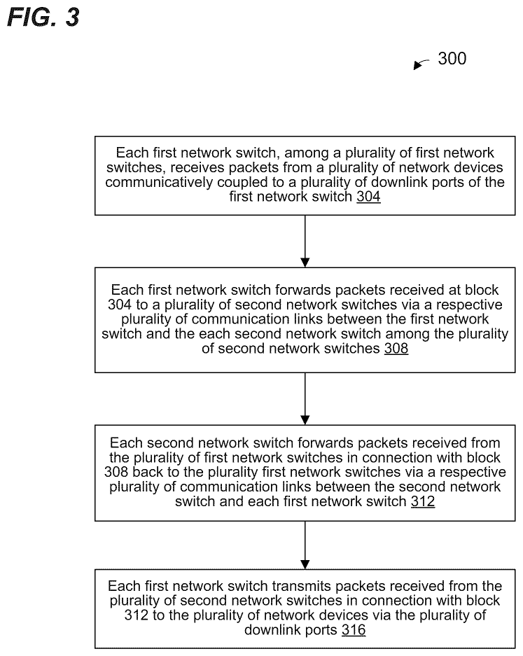

FIG. 3 is a flow diagram of an example method 300 for communicating in a communication network that includes i) a plurality of first network switches, and ii) a plurality of second network switches communicatively coupled to the first plurality of first network switches, according to an embodiment. The method 300 is implemented in the example communication network 100 of FIG. 1A, according to an embodiment, and the method 300 is described with reference to FIGS. 1A-B for ease of explanation. The method 300 is implemented in the example communication network 200 of FIG. 2A, according to another embodiment, and the method 300 is also described with reference to FIGS. 2A-D for ease of explanation.

In other embodiments, the method 300 is implemented in another suitable communication network different than the example communication networks 100, 200 of FIGS. 1A and 2A. Similarly, the communication network 100 of FIG. 1A and/or the communication network 200 of FIG. 2A implement another suitable method different than the method 300, in some embodiments.

In an embodiment, the method 300 is implemented in a communication network in which each first network switch (e.g., each network switch 116, each network switch 216, etc.) has at least 200 downlink ports, and each second network switch (e.g., each network switch 124, each network switch 224, etc.) comprises a respective plurality of ports coupled to at least one uplink port of each of the first network switches. In another embodiment, the method 300 is implemented in a communication network in which, additionally or alternatively, the plurality of first network switches comprises at least first 1000 first network switches.

In an embodiment, the method 300 is implemented in a communication network in which each second network switch comprises at least 1000 ports communicatively coupled to respective first network switches, and optionally each port is configured to operation at a data rate of at least 100 Gbps. In another embodiment, the method 300 is implemented in a communication network in which each second network switch comprises at least 500 ports communicatively coupled to respective first network switches, and optionally each port is configured to operation at a data rate of at least 200 Gbps.

At block 304, each first network switch among the plurality of first network switches receives packets from a plurality of network devices via the plurality of downlink ports. For example, each network switch 116 receives packets via the plurality of downlink ports. As another example, each network switch 216 receives packets via the plurality of downlink ports. In an embodiment, receiving packets at block 304 comprises receiving packets via at least 200 downlink ports of the first network switch.

In an embodiment, each first network switch receives packets at block 304 from a plurality of GPUs (e.g., the GPUs 112). In another embodiment, each first network switch receives packets at block 304 additionally or alternatively from other suitable network devices such as memory devices, servers, other network switches, etc.

In an embodiment, receiving packets at block 304 comprises the first network switch receiving data at each downlink port at a data rate of at least 100 Gbps.

In an embodiment, each first network switch is communicatively coupled to a respective computational pod amongst a plurality of computational pods (e.g., the computational pods 108), each computational pod including a plurality of network devices (e.g., GPUs, memory devices, servers, etc.), and each downlink port of the first network switch is communicatively coupled to a respective network device in the computational pod. In another embodiment, each first network switch is communicatively coupled to a respective pair of computational pods amongst a plurality of computational pods (e.g., the computational pods 108), each computational pod including a plurality of network devices (e.g., GPUs, memory devices, servers, etc.), and each downlink port of the first network switch is communicatively coupled to a respective network device in the pair of computational pods.

At block 308, each first network switch forwards packets received at block 304 to the plurality of second network switches via a respective plurality of communication links between the first network switch and each second network switch in the plurality of second switches. For example, each network switch 116 forwards packets via the plurality of uplink ports. As another example, each network switch 216 forwards packets via the plurality of uplink ports. In an embodiment, forwarding packets at block 308 comprises forwarding packets via at least 200 uplink ports of the first network switch.

In an embodiment, forwarding packets at block 308 comprises the first network switch forwarding data at each uplink port at a data rate of at least 100 Gbps. In another embodiment, forwarding packets at block 308 comprises the first network switch forwarding data at each uplink port at a data rate of at least 200 Gbps.

At block 312, each second network switch forwards packets received from the first network switches in connection with block 308 to the first network switches via a respective plurality of communication links between the second network switch and each first network switch. For example, each network switch 124 forwards packets via the plurality ports of the network switch 124. As another example, each network switch 224 forwards packets via the plurality of ports of the network switch 224.

In an embodiment, forwarding packets at block 312 comprises forwarding packets via at least 1000 ports of the second network switch. In another embodiment, forwarding packets at block 312 comprises forwarding packets via at least 500 ports of the second network switch.

In an embodiment, forwarding packets at block 312 comprises the second network switch forwarding data by each port of the second network switch at a data rate of at least 100 Gbps. In another embodiment, forwarding packets at block 312 comprises the second network switch forwarding data by each port of the second network switch at a data rate of at least 200 Gbps.

At block 316, each first network switch transmits packets received from the plurality of second network switches in connection with block 312 to the at least 200 network devices via the plurality of downlink ports.

For example, each network switch 116 transmits packets via the plurality of downlink ports. As another example, each network switch 216 transmits packets via the plurality of downlink ports. In an embodiment, transmitting packets at block 316 comprises transmitting packets via at least 200 downlink ports of the first network switch.

In an embodiment, each first network switch transmits packets at block 316 to a plurality of GPUs (e.g., the GPUs 112). In another embodiment, each first network switch transmits packets at block 316 additionally or alternatively to other suitable network devices such as memory devices, servers, other network switches, etc.

In an embodiment, transmitting packets at block 316 comprises the first network switch transmitting data at each downlink port at a data rate of at least 100 Gbps.

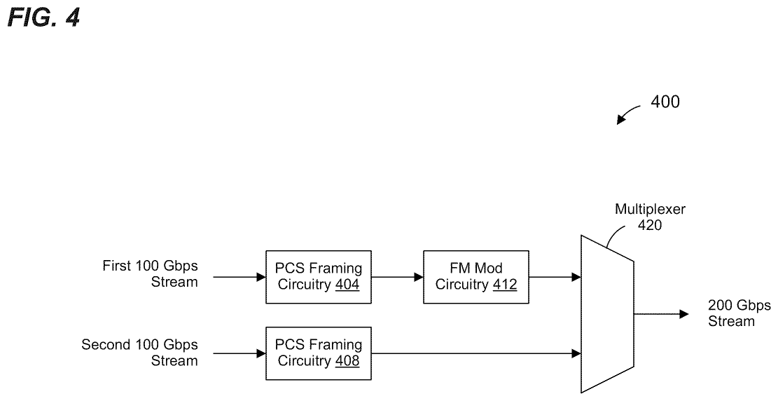

FIG. 4 is a simplified block diagram of example multiplexer circuitry 400 that is included in communication networks such as described above, and/or in other suitable communication networks. For example, the multiplexer circuitry 400 is included in the mux/demux 152 of FIGS. 1A-B and/or the mux/demux 190 of FIG. 1C, in an embodiment. In other embodiments, the mux/demux 152 of FIGS. 1A-B and/or the mux/demux 190 of FIG. 1C include other suitable multiplexer circuitry different than the multiplexer circuitry 400.

As another example, the multiplexer circuitry 400 is included in the mux/demux 232, 256 of FIGS. 2A-B, in another embodiment. As another example, the multiplexer circuitry 400 is included in the mux/demux 284 of FIG. 2C and/or the mux/demux 296 of FIG. 2D, in another embodiment. In other embodiments, the mux/demux 232, 256 of FIGS. 2A-B, the mux/demux 284 of FIG. 2C, and/or the mux/demux 296 of FIG. 2D include other suitable multiplexer circuitry different than the multiplexer circuitry 400.

The multiplexer circuitry 400 includes physical coding sublayer (PCS) framing circuitry 404 that is configured to receive, at a first data rate (e.g., 100 Gbps), first data corresponding to a first data stream, and to generate first PCS frames using the first data. In an embodiment, generating first PCS frames includes adding a frame marker (FM) to each first PCS frame to denote boundaries between adjacent first PCS frames.

The multiplexer circuitry 400 also includes PCS framing circuitry 408 that is configured to receive, at the first data rate (e.g., 100 Gbps), second data corresponding to a second data stream, and to generate second PCS frames using the second data. In an embodiment, generating second PCS frames includes adding the FM to each second PCS frame to denote boundaries between adjacent second PCS frames.

Frame marker modification circuitry 412 is coupled to the PCS framing circuitry 404. The frame marker modification circuitry 412 is configured to modify FMs added by the PCS framing circuitry 404 to distinguish PCS frames corresponding to the first data stream from PCS frames corresponding to the second data stream. For example, the frame marker modification circuitry 412 is configured to invert bits of the FMs added by the PCS framing circuitry 404, in an embodiment. As another example, the frame marker modification circuitry 412 is configured to invert a subset of bits of the FMs added by the PCS framing circuitry 404, in another embodiment. As another example, the frame marker modification circuitry 412 is configured to modify bits of the FMs added by the PCS framing circuitry 404 in another suitable manner, in another embodiment.

In other embodiments, the frame marker modification circuitry 412 is configured replace FMs added by the PCS framing circuitry 404 with another FM that is different than the FMs added by the PCS framing circuitry 404 to distinguish PCS frames corresponding to the first data stream from PCS frames corresponding to the second data stream.

The frame markers added by the PCS framing circuitry 404 are sometimes referred to herein as “unmodified frame markers,” and the frame markers output by the frame marker modification circuitry 412 are sometimes referred to herein as “modified frame markers.”

In another embodiment, the frame marker modification circuitry 412 is omitted and the PCS framing circuitry 404 is configured to add a modified frame marker to each first PCS frame that is different than the FMs added by the PCS framing circuitry 408 to the second PCS frames.

The multiplexer circuitry 400 also includes a multiplexer 420. An output of the frame marker modification circuitry 412 is coupled to a first input of the multiplexer 420, and an output of the PCS framing circuitry 408 is coupled to a second input of the multiplexer 420. In embodiments in which the frame marker modification circuitry 412 is omitted, an output of the PCS framing circuitry 404 is coupled to the first input of the multiplexer 420.

The multiplexer 420 is configured to generate an output at a data rate that is at least double the data rate of the inputs to the multiplexer 420 by alternating between i) providing a symbol (e.g., a group of bits) from the first input to the output of the multiplexer, and ii) providing a symbol from the second input to the output of the multiplexer, in an embodiment.

In an embodiment in which the first data stream and the second data stream are each received at 100 Gbps, the multiplexer 420 generates an output data stream at a data rate of 200 Gbps.

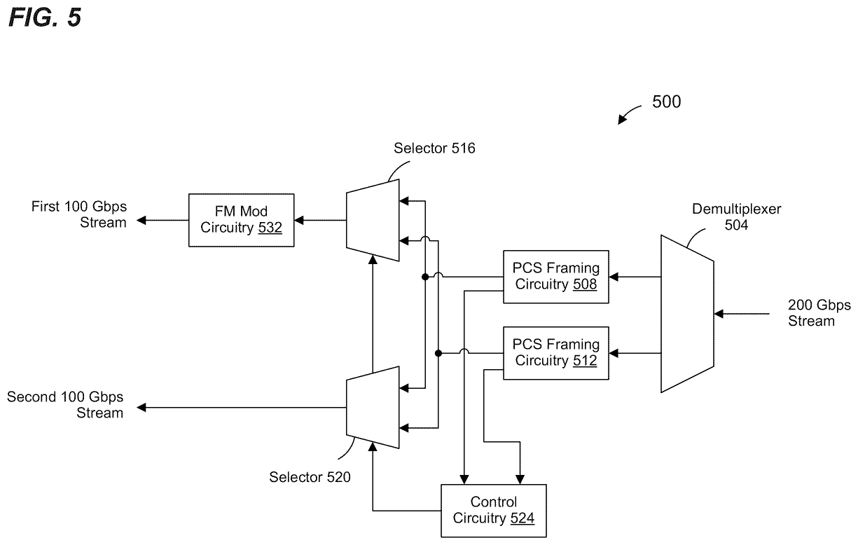

FIG. 5 is a simplified block diagram of example demultiplexer circuitry 500 that is included in communication networks such as described above, and/or in other suitable communication networks. For example, the demultiplexer circuitry 500 is included in the mux/demux 152 of FIGS. 1A-B and/or the mux/demux 190 of FIG. 1C, in an embodiment. In other embodiments, the mux/demux 152 of FIGS. 1A-B and/or the mux/demux 190 of FIG. 1C include other suitable demultiplexer circuitry different than the demultiplexer circuitry 500.

As another example, the demultiplexer circuitry 500 is included in the mux/demux 232, 256 of FIGS. 2A-B, in another embodiment. As another example, the demultiplexer circuitry 500 is included in the mux/demux 284 of FIG. 2C and/or the mux/demux 296 of FIG. 2D, in another embodiment. In other embodiments, the mux/demux 232, 256 of FIGS. 2A-B, the mux/demux 284 of FIG. 2C, and/or the mux/demux 296 of FIG. 2D include other suitable demultiplexer circuitry different than the demultiplexer circuitry 500.

The demultiplexer circuitry 500 includes a demultiplexer 504. An input of the demultiplexer 504 is configured to receive an input data stream at a first data rate. The multiplexer 504 is configured to generate two outputs each at a second data rate that is one half of the first data rate by alternating between i) providing one symbol (e.g., a group of bits) from the input to the first output of the multiplexer 504, and ii) providing a subsequent symbol from the input to the second output of the multiplexer 504, in an embodiment.

In an embodiment in which the input data stream is received at a data rate of 200 Gbps, the demultiplexer 504 is configured to generate a first output data stream and a second output data stream each at 100 Gbps.

The first output of the demultiplexer 504 is coupled to an input of PCS framing circuitry 508, and the second output of the demultiplexer 504 is coupled to an input of PCS framing circuitry 512. The PCS framing circuitry 508 is configured to i) identify frame markers in the first output of the demultiplexer 504, and ii) output symbols that are aligned with the frame markers. Additionally, the PCS framing circuitry 508 is configured to output an indication of whether the identified frame markers are unmodified frame markers or modified frame markers.

The PCS framing circuitry 512 is configured to i) identify frame markers in the second output of the demultiplexer 504, and ii) output symbols that are aligned with the frame markers. Additionally, the PCS framing circuitry 512 is configured to output an indication of whether the identified frame markers are unmodified frame markers or modified frame markers.

Symbols output by the PCS framing circuitry 508 are provided to a first input of a selector circuit 516 and to a first input of a selector circuit 520. Symbols output by the PCS framing circuitry 512 are provided to a second input of a selector circuit 516 and to a second input of a selector circuit 520.

Control circuitry 524 receives, from the PCS framing circuitry 508, the indication of whether the identified frame markers in the first output of the demultiplexer 504 are unmodified frame markers or modified frame markers. Additionally, the control circuitry 524 receives, from the PCS framing circuitry 512, the indication of whether the identified frame markers in the second output of the demultiplexer 504 are unmodified frame markers or modified frame markers. The control circuitry 524 uses the indications received from the PCS framing circuitry 508 and the PCS framing circuitry 512 to generate control signals for controlling the selector circuit 516 and the selector circuit 520. In particular, when the indications received from the PCS framing circuitry 508 and the PCS framing circuitry 512 indicate that i) the frame markers in the first output of the demultiplexer 504 are modified frame markers, and ii) that the frame markers in the second output of the demultiplexer 504 are unmodified frame markers, the control circuitry 524 generate control signals that cause i) the selector circuit 516 to select an output of the PCS framing circuitry 508, and ii) the selector circuit 520 to select an output of the PCS framing circuitry 512. On the other hand, when the indications received from the PCS framing circuitry 508 and the PCS framing circuitry 512 indicate that i) the frame markers in the first output of the demultiplexer 504 are unmodified frame markers, and ii) that the frame markers in the second output of the demultiplexer 504 are modified frame markers, the control circuitry 524 generate control signals that cause i) the selector circuit 516 to select an output of the PCS framing circuitry 512, and ii) the selector circuit 520 to select an output of the PCS framing circuitry 508.

The demultiplexer circuitry 500 also includes frame marker modification circuitry 532 that is coupled to an output of the selector circuit 516. The frame marker modification circuitry 532 is configured to convert modified FMs in the output of the selector circuit 516 to unmodified FMs.

Referring again to FIGS. 2A, 2C and 4, the optical transceiver 288-1 is communicatively connected to a first GPU 112, and the optical transceiver 288-2 is communicatively connected to a second GPU 112; and the multiplexer 420 multiplexes a first stream from the first GPU 112 and a second stream from the second GPU 112, according to an embodiment. In an embodiment, a first transmit clock of a first network interface (e.g., a first Ethernet interface) of the first GPU 112 is synchronized with a second transmit clock of a second network interface (e.g., a second Ethernet interface) of the second GPU 112. In an embodiment, the first network interface (e.g., the first Ethernet interface) of the first GPU 112 and/or the second network interface (e.g., the second Ethernet interface) of the second GPU 112 includes circuitry configured to synchronize the first transmit clock of the first network interface with the second transmit clock of the second network interface.

In another embodiment corresponding to FIGS. 2A and C, the first transmit clock of the first network interface (e.g., the first Ethernet interface) of the first GPU 112 is unsynchronized with the second transmit clock of the second network interface (e.g., the second Ethernet interface) of the second GPU 112. In some such embodiments, multiplexer circuitry of the mux/demux 284 of FIG. 2C includes circuitry configured to synchronize the first stream from the first GPU 112 and the second stream from the second GPU 112 prior to multiplexing the first stream and the second stream.

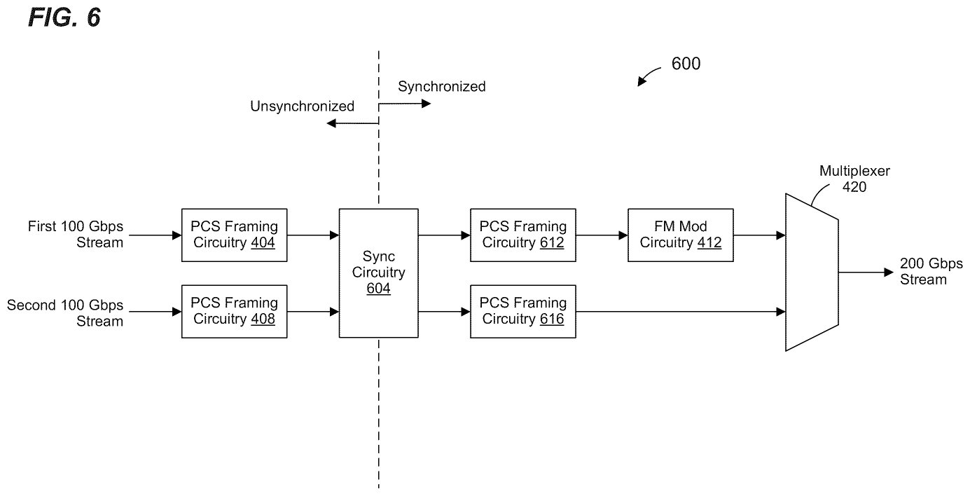

FIG. 6 is a simplified block diagram of example multiplexer circuitry 600 that is included in communication networks such as described above, and/or in other suitable communication networks, according to another embodiment. For example, the multiplexer circuitry 600 is included in the mux/demux 284 of FIG. 2C, in an embodiment. In other embodiments, the mux/demux 284 of FIG. 2C includes other suitable multiplexer circuitry different than the multiplexer circuitry 600.

The multiplexer circuitry 600 of FIG. 6 is similar to the multiplexer circuitry 400 of FIG. 4, and like-numbered elements are not described again in detail for brevity.

In the embodiment of FIG. 6, outputs of the PCS framing circuitry 404 and the PCS framing circuitry 408 are unsynchronized. For example, a first transmit clock corresponding to the first 100 Gbps stream is unsynchronized with respect to a second transmit clock corresponding to the second 100 Gbps stream. Synchronization circuitry 604 is coupled to the PCS framing circuitry 404 and the PCS framing circuitry 408 and processes outputs of the PCS framing circuitry 404 and the PCS framing circuitry 408 to generate a first processed stream corresponding to the first 100 Gbps stream that is synchronized with a second processed stream corresponding to the second 100 Gbps stream. In an embodiment, the synchronization circuitry 604 includes circuitry configured to generate the first processed stream and the second processed stream at least by modifying lengths of inter-frame gaps (IFGs) in the output of the PCS framing circuitry 404 and/or the output of the PCS framing circuitry 408 at least as part of generating the first processed stream and the second processed stream that are synchronized. In an embodiment, IFGs in the output of the PCS framing circuitry 404 and the output of the PCS framing circuitry 408 include idle symbols, and modifying a length of an IFG includes removing one or more idle symbols or adding one or more idle symbols.

In another embodiment, the synchronization circuitry 604 additionally or alternatively includes one or memory devices (e.g., one or more registers, one or more latches, etc.) for delaying the output of the PCS framing circuitry 404 and/or the output of the PCS framing circuitry 408 at least as part of generating the first processed stream and the second processed stream that are synchronized.

The multiplexer circuitry 600 also includes PCS framing circuitry 612 coupled to the synchronization circuitry 604, and PCS framing circuitry 616 coupled to the synchronization circuitry 604. The PCS framing circuitry 612 is configured to receive first data corresponding to the first processed data stream, and to generate first PCS frames using the first data. The PCS framing circuitry 616 is configured to receive second data corresponding to the second processed data stream, and to generate second PCS frames using the second data.

An output of the PCS framing circuitry 612 is coupled to the input of the FM modification circuitry 412, and an output of the PCS framing circuitry 612 is coupled to one of the inputs of the multiplexer 420.

In another embodiment, the PCS framing circuitry 612 and the PCS framing circuitry 616 are omitted. For example, one output of the synchronization circuitry 604 is coupled to the input of the FM modification circuitry 412, and an output of the PCS framing circuitry 612 is coupled to one of the inputs of the multiplexer 420.

In another embodiment, the PCS framing circuitry 404 and the PCS framing circuitry 408 are omitted.

In some embodiments, multiplexer circuitry like the multiplexer circuitry 400 of FIG. 4, the multiplexer circuitry 600 of FIG. 6, etc., includes circuitry that causes symbols of forward error correction (FEC) codewords to be interleaved in the output of the multiplexer 420 so that adjacent symbols in the output are from different FEC codewords.

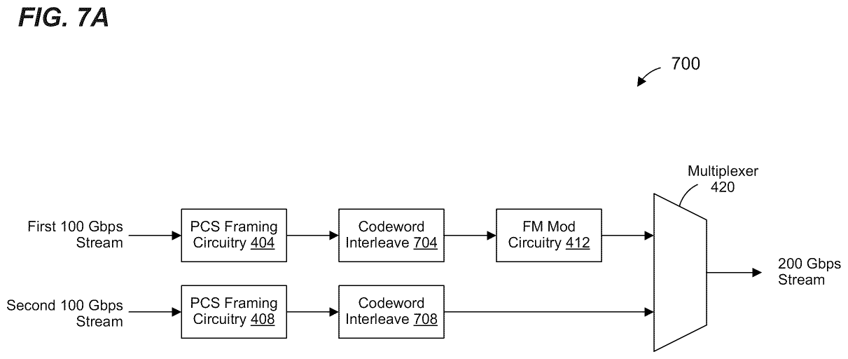

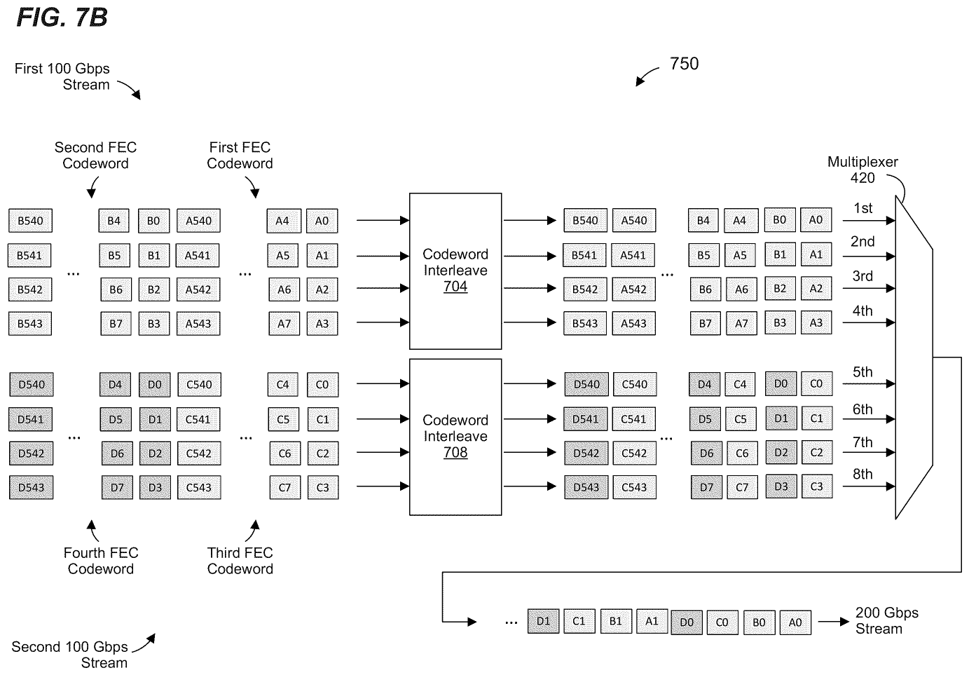

FIG. 7A is a simplified block diagram of example multiplexer circuitry 700 that is included in communication networks such as described above, and/or in other suitable communication networks, according to another embodiment. For example, the multiplexer circuitry 700 is included in the mux/demux 152 of FIGS. 1A-B and/or the mux/demux 190 of FIG. 1C, in an embodiment. In other embodiments, the mux/demux 152 of FIGS. 1A-B and/or the mux/demux 190 of FIG. 1C include other suitable multiplexer circuitry different than the multiplexer circuitry 700.

As another example, the multiplexer circuitry 700 is included in the mux/demux 232, 256 of FIGS. 2A-B, in another embodiment. As another example, the multiplexer circuitry 700 is included in the mux/demux 284 of FIG. 2C and/or the mux/demux 296 of FIG. 2D, in another embodiment. In other embodiments, the mux/demux 232, 256 of FIGS. 2A-B, the mux/demux 284 of FIG. 2C, and/or the mux/demux 296 of FIG. 2D include other suitable multiplexer circuitry different than the multiplexer circuitry 700.

The multiplexer circuitry 700 of FIG. 7A is similar to the multiplexer circuitry 400 of FIG. 4, and like-numbered elements are not described again in detail for brevity.

Codeword interleaver circuitry 704 is coupled to the PCS framing circuitry 404 and processes outputs of the PCS framing circuitry 404 to generate a first interleaved stream corresponding to the first 100 Gbps stream. For example, the codeword interleaver circuitry 704 is configured to interleave symbols of multiple FEC codewords received from the PCS framing circuitry 404.

Codeword interleaver circuitry 708 is coupled to the PCS framing circuitry 408 and processes outputs of the PCS framing circuitry 408 to generate a second interleaved stream corresponding to the second 100 Gbps stream. For example, the codeword interleaver circuitry 708 is configured to interleave symbols of multiple FEC codewords received from the PCS framing circuitry 408.

FIG. 7B is a simplified diagram illustrating an example interleaving function performed by the codeword interleaver circuitry 704 and the codeword deinterleaver circuitry 708, according to an embodiment.

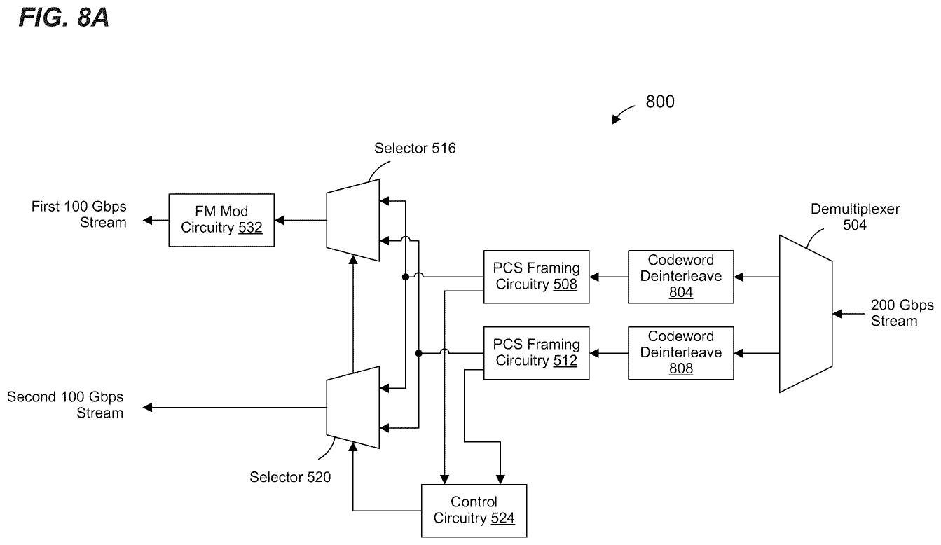

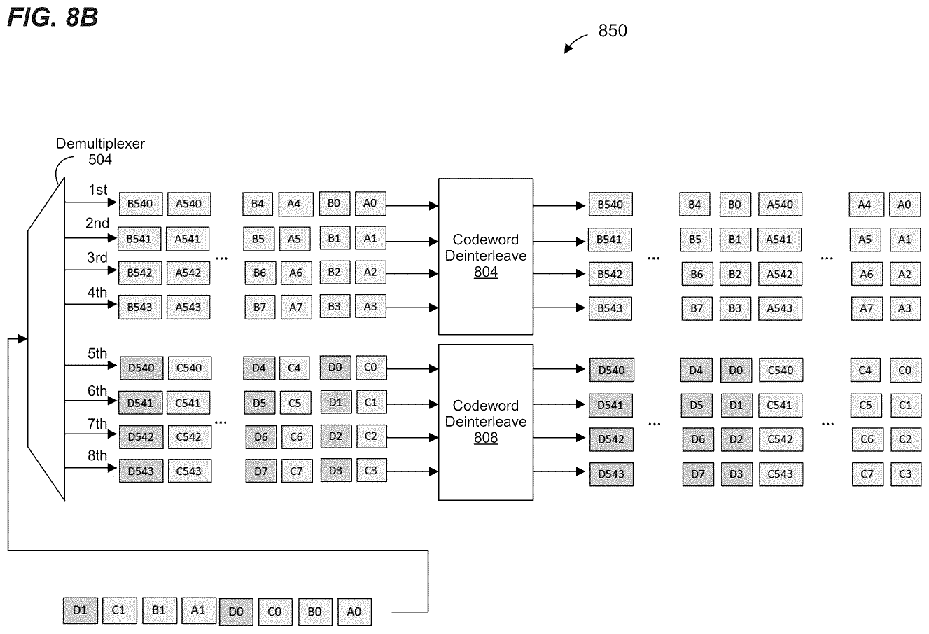

FIG. 8A is a simplified block diagram of example demultiplexer circuitry 800 that is included in communication networks such as described above, and/or in other suitable communication networks, according to another embodiment. For example, the demultiplexer circuitry 800 is included in the mux/demux 152 of FIGS. 1A-B and/or the mux/demux 190 of FIG. 1C, in an embodiment. In other embodiments, the mux/demux 152 of FIGS. 1A-B and/or the mux/demux 190 of FIG. 1C include other suitable multiplexer circuitry different than the multiplexer circuitry 400.

As another example, the demultiplexer circuitry 800 is included in the mux/demux 232 of FIGS. 2A-B, in another embodiment. As another example, the demultiplexer circuitry 800 is included in the mux/demux 284 of FIG. 2C and/or the mux/demux 296 of FIG. 2D, in another embodiment. In other embodiments, the mux/demux 232 of FIGS. 2A-B, the mux/demux 284 of FIG. 2C, and/or the mux/demux 296 of FIG. 2D include other suitable demultiplexer circuitry different than the demultiplexer circuitry 800.

The demultiplexer circuitry 800 of FIG. 8A is similar to the demultiplexer circuitry 500 of FIG. 5, and like-numbered elements are not described again in detail for brevity.

The demultiplexer 504 is configured to receive a combined stream of alternating symbols from multiple different FEC codewords and to demultiplex the combined stream into a first interleaved stream and a second interleaved stream. The first interleaved stream output by the demultiplexer 504 includes interleaved FEC codewords corresponding to one of i) the first 100 Gbps stream, and ii) the second 100 Gbps stream; and the second interleaved stream output by the demultiplexer 504 includes interleaved FEC codewords corresponding to another one of i) the first 100 Gbps stream, and ii) the second 100 Gbps stream.

Codeword deinterleaver circuitry 804 is coupled to a first output of the demultiplexer 504 and processes the first interleaved stream to generate a first deinterleaved stream corresponding to one of i) the first 100 Gbps stream, and ii) the second 100 Gbps stream. For example, the codeword deinterleaver circuitry 804 is configured to deinterleave symbols of multiple FEC codewords received from the demultiplexer 504.

Codeword deinterleaver circuitry 808 is coupled to a second output of the demultiplexer 504 and processes the second interleaved stream to generate a first deinterleaved stream corresponding to the other one of i) the first 100 Gbps stream, and ii) the second 100 Gbps stream. For example, the codeword deinterleaver circuitry 808 is configured to deinterleave symbols of multiple FEC codewords received from the demultiplexer 504.

An output of the deinterleaver circuitry 804 is coupled to an input of the PCS framing circuitry 508; and an output of the deinterleaver circuitry 808 is coupled to an input of the PCS framing circuitry 512.

FIG. 8B is a simplified diagram illustrating an example deinterleaving function performed by the codeword deinterleaver circuitry 804 and the codeword deinterleaver circuitry 808, according to an embodiment.

FIG. 8B illustrates streams being transferred within the demultiplexer circuitry 800 via multiple lanes (e.g., four). In other embodiments, streams are transferred via another suitable number of lanes different than four.

The demultiplexer 504 receives the combined stream of alternating symbols from multiple different FEC codewords, and alternately outputs sets of symbols on alternate outputs corresponding to respective lanes. For example, the demultiplexer 504 outputs two symbols to the first output; then outputs two symbols to the fifth output; then outputs two symbols to the second output; then outputs two symbols to the sixth output; then outputs two symbols to the third output; then outputs two symbols to the seventh output; then outputs two symbols to the fourth output; and then outputs two symbols to the eighth output; etc., according to an embodiment.

The first through fourth outputs of the demultiplexer 504 correspond to the first interleaved stream, and the fifth through eighth outputs correspond to the second interleaved stream. Operation of the demultiplexer 504 in the manner described above results in the first interleaved stream including interleaved FEC codeword symbols from a first FEC codeword and a second FEC codeword, and the second interleaved stream including interleaved FEC codeword symbols from a third FEC codeword and a fourth FEC codeword. Additionally, operation of the demultiplexer 504 in the manner described above results in the first interleaved stream corresponding to one of i) the first 100 Gbps stream, and ii) the second 100 Gbps stream, and the second interleaves stream corresponding to the other one of i) the first 100 Gbps stream, and ii) the second 100 Gbps stream.

In the example of FIG. 8B, symbols from the first FEC codeword and the second FEC codeword alternate on each lane between the demultiplexer 504 and the codeword deinterleave circuitry 804, and symbols from the third FEC codeword and the fourth FEC codeword alternate on each lane between the demultiplexer 504 and the codeword deinterleave circuitry 808.

In the example of FIG. 8B, the codeword deinterleave circuitry 804 deinterleaves the first through fourth lanes output by the demultiplexer 504 to output the entirety of the first FEC codeword before outputting the second FEC codeword. Similarly, the codeword deinterleave circuitry 808 deinterleaves the fifth through eighth lanes output by the demultiplexer 504 to output the entirety of the third FEC codeword before outputting the fourth FEC codeword.

A first lane output by the codeword deinterleave circuitry 804/808 carries the first, fifth, ninth, etc., symbols of an FEC codeword; a second lane carries the second, sixth, tenth, etc., symbols of the FEC codeword 708; a third lane carries the third, seventh, eleventh, etc., symbols of the FEC codeword; and a fourth lane carries the fourth, ninth, twelfth, etc., symbols of the FEC codeword.

Referring again to FIGS. 2A-C, in other embodiments the number of cables is further reduced by transmitting more than two streams (e.g., 100 Gbps streams) via a single cable between a switch 216 and a switch 224. As an illustrative example, four 100 Gbps streams are transmitted between a switch 216 and a switch 224 via a single cable rated for 400 Gbps, in an embodiment.

For example, referring to FIG. 2B, the port module 226 is modified to couple to two 200 Gbps streams to/from the switch chip 140, and to transmit/receive 400 Gbps via a 400 G cable; the port module 244 is modified to transmit/receive 400 Gbps via the 400 G cable, and couple to four 100 Gbps streams to/from four switch chips 172, according to an embodiment. Referring to FIG. 2C, in another embodiment, the port module 276 is modified to transmit/receive 400 Gbps via a 400 G cable, and couple to two 200 Gbps streams to/from two switch chips 272.

Referring to FIGS. 1C and 2B, the switch chip 140 is modified so that each mux/demux 190 multiplexes four 100 Gbps streams to a 400 Gbps stream and demultiplexes a 400 Gbps stream to four 100 Gbps streams; the SERDES 160 operate at a data rate of at least 400 Gbps; the port module 226 is modified to couple to a 400 Gbps streams to/from the switch chip 140, and to transmit/receive 400 Gbps via a 400 G cable; the port module 244 is modified to transmit/receive 400 Gbps via the 400 G cable, and couple to four 100 Gbps streams to/from four switch chips 172, according to an embodiment. Referring to FIGS. 2C and D, in another embodiment, the switch chip 272 is modified so that each mux/demux 296 multiplexes four 100 Gbps streams to a 400 Gbps stream and demultiplexes a 400 Gbps stream to four 100 Gbps streams; the SERDES 294 operate at a data rate of at least 400 Gbps; the port module 276 is modified to transmit/receive 400 Gbps via a 400 G cable, and couple to a 400 Gbps streams to/from two switch chips 272; the port module 280 is modified so that each mux/demux 284 multiplexes four 100 Gbps streams to a 400 Gbps stream and demultiplexes a 400 Gbps stream to four 100 Gbps streams; the SERDES 286 operate at a data rate of at least 400 Gbps.

Embodiment 1: A communication network, comprising: a plurality of first switches, each first switch having i) a respective first integrated circuit (IC) switch chip having a plurality of network interfaces, ii) a respective plurality of downlink ports, and iii) a respective plurality of uplink ports; and a plurality of second switches, each second switch having i) a respective plurality of ports coupled to at least one uplink port of each of the first switches, ii) a respective second IC switch chip in a respective IC package, the second IC switch chip having a plurality of external network interfaces coupled to external interconnects of the IC package, and iii) a respective plurality of serializers/deserializers (SERDES) to communicatively couple the respective plurality of external network interfaces to the respective plurality of ports of the second switch. Each second IC switch chip further comprises: a plurality of internal network interfaces; a packet processor coupled to the plurality of internal network interfaces, the packet processor configured to forward packets amongst internal network interfaces of the plurality of internal network interfaces; and a plurality of multiplexer/demultiplexer circuitry, each multiplexer/demultiplexer circuitry coupled to i) a respective external network interface, and ii) a respective set of multiple internal network interfaces, each multiplexer/demultiplexer circuitry configured to i) demultiplex a first data stream received from the respective external network interface into a second data stream and a third data stream for transfer to the respective set of multiple internal network interfaces, and ii) multiplex a fourth data stream and a fifth data stream received via the respective set of multiple internal network interfaces into a sixth data stream for transfer to the respective external network interface.

Embodiment 2: The communication network of embodiment 1, wherein the plurality of multiplexer/demultiplexer circuitry is a plurality of first multiplexer/demultiplexer circuitry, and wherein each second switch further comprises: a respective plurality of second multiplexer/demultiplexer circuitry coupled to the respective plurality of SERDES, each second multiplexer/demultiplexer circuitry configured to i) demultiplex the sixth data stream received from a respective external network interface of the second IC switch chip via the SERDES into an eighth data stream and a ninth data stream for transmission via a respective pair of ports of the second switch, and ii) multiplex a tenth data stream and an eleventh data stream received via the respective pair of ports of the second switch into the first data stream for transmission to the respective external network interface of the second IC switch chip via the SERDES.

Embodiment 3: The communication network of embodiment 2, wherein: each second IC switch chip includes at least 1000 internal network interfaces; each second IC switch chip includes at least 500 external network interfaces; and each second switch includes at least 1000 ports communicatively coupled to the at least 500 external network interfaces of the respective second IC switch chip.

Embodiment 4: The communication network of any of embodiments 1-3, wherein the plurality of SERDES is a plurality of first SERDES, and wherein each external network interface of the second IC switch chip comprises, or is coupled to: a respective second SERDES coupled to the respective multiplexer/demultiplexer circuitry, the respective second SERDES configured to i) transfer the first data stream from the external network interface to the multiplexer/demultiplexer circuitry, and ii) transfer the sixth data stream from the multiplexer/demultiplexer circuitry to the external network interface.

Embodiment 5: The communication network of any of embodiments 1-4, wherein each multiplexer/demultiplexer circuitry comprises: forward error correction (FEC) codeword interleaver circuitry configured to i) interleave symbols of multiple FEC codewords in the fourth data stream, and ii) and interleave symbols of multiple FEC codewords in the fifth data stream; and FEC codeword deinterleaver circuitry configured to i) deinterleave symbols of multiple FEC codewords in the second data stream, and ii) deinterleave symbols of multiple FEC codewords in the third data stream.

Embodiment 6: The communication network of any of embodiments 1-5, wherein the plurality of SERDES is a plurality of first SERDES, wherein the plurality of multiplexer/demultiplexer circuitry is a plurality of first multiplexer/demultiplexer circuitry, and wherein each first switch further comprises: at least two respective first IC switch chips; and a respective plurality of second multiplexer/demultiplexer circuitry coupled to a respective plurality of second SERDES, each second multiplexer/demultiplexer circuitry configured to i) demultiplex a seventh data stream received via a respective uplink port into an eighth data stream and a ninth data stream for transmission to a respective pair of network interfaces of the first switch, and ii) multiplex a tenth data stream and an eleventh data stream received from the respective pair of network interfaces of the first switch into a twelfth data stream for transmission via the respective uplink port.

Embodiment 7: The communication network of embodiment 6, wherein: each second IC switch chip includes at least 1000 internal network interfaces; each second IC switch chip includes at least 500 external network interfaces; each external network interface operates at a data rate of least 200 gigabits per second; and each second switch includes at least 500 ports communicatively coupled to the at least 500 external network interfaces of the respective second IC switch chip.

Embodiment 8: The communication network of any of embodiments 1-7, wherein the respective IC package is a respective first IC package, wherein the plurality of internal network interfaces is a plurality of first internal network interfaces, wherein the plurality of external network interfaces is a plurality of first external network interfaces coupled to first external interconnects of the first IC package, wherein the packet processor is a first packet processor, wherein the plurality of multiplexer/demultiplexer circuitry is a plurality of first multiplexer/demultiplexer circuitry, and wherein each first IC switch chip of each first switch is included in a respective second IC package. Each first IC switch chip including: a plurality of second external network interfaces coupled to second external interconnects of the second IC package; a plurality of second internal network interfaces; a second packet processor coupled to the plurality of second internal network interfaces, the second packet processor configured to forward packets amongst second internal network interfaces of the plurality of second internal network interfaces; and a plurality of second multiplexer/demultiplexer circuitry, each second multiplexer/demultiplexer circuitry coupled to i) a respective second external network interface, and ii) a respective set of multiple second internal network interfaces, each second multiplexer/demultiplexer circuitry configured to i) demultiplex a seventh data stream received from the respective second external network interface into an eighth data stream and a ninth data stream for transfer to the respective set of multiple second internal network interfaces, and ii) multiplex a tenth data stream and an eleventh data stream received via the respective set of multiple second internal network interfaces into a twelfth data stream for transfer to the respective second external network interface.

Embodiment 9: The communication network of embodiment 8, wherein the plurality of SERDES is a plurality of first SERDES, and wherein each first switch further comprises: a plurality of second SERDES coupled to respective second external network interfaces that correspond to downlink ports of the first switch; and a plurality of third multiplexer/demultiplexer circuitry coupled to the plurality of second SERDES, each third multiplexer/demultiplexer circuitry configured to i) demultiplex the twelfth data stream received from a respective second external network interface of the second IC switch chip via the respective second SERDES into a thirteenth data stream and a fourteenth data stream for transmission via a respective pair of downlink ports of the first switch, and ii) multiplex a fifteenth data stream and a sixteenth data stream received via the respective pair of downlink ports of the first switch into the seventh data stream for transmission to the respective second external network interface of the second IC switch chip via the respective third SERDES.

Embodiment 10: The communication network of one of embodiments 8 and 9, wherein: each first IC switch chip includes at least 1000 second internal network interfaces; each first IC switch chip includes at least 500 second external network interfaces; and each first switch includes at least 500 downlink ports communicatively coupled to at least 250 second external network interfaces of the respective first IC switch chip.

Embodiment 11: A method for communicating in a communication network that includes i) a plurality of first network switches, and ii) a plurality of second network switches, each first network switch comprising i) a respective plurality of downlink ports, ii) a respective plurality of uplink ports, and iii) a respective one or more first integrated circuit (IC) switch chips communicatively coupled to the plurality of uplink ports and the plurality of downlink ports, and each second network switch comprising i) a respective plurality of ports coupled to at least one uplink port of each of the first network switches, and ii) a respective second IC switch chip communicatively coupled to the plurality of ports of the second switch, the method comprising: receiving, at each first network switch among the plurality of first network switches, packets from network devices via the plurality of downlink ports; forwarding, by each first network switch, packets received via the plurality of downlink ports to the plurality of second network switches via a respective plurality of communication links between the first network switch and each second network switch in the plurality of second switches; at each second switch, transferring packets received from the plurality of first switches to external network interfaces of the second IC switch chip; in connection with each external network interface of each second IC switch chip, demultiplexing a respective first stream of packets received via the external network interface to multiple internal network interfaces of the second IC switch chip; at each second IC switch chip, forward packets received via the internal network interfaces of the second IC switch chip amongst the internal network interfaces of the second IC switch chip; in connection with each external network interface of each second IC switch chip, multiplexing at least a second stream of packets and a third stream of packets received via multiple internal network interfaces of the second IC switch chip to the external network interface; forwarding, by each second network switch, packets received from external network interfaces of the respective second IC switch chip to the plurality of first network switches via a respective plurality of communication links between the second network switch and each first network switch among the plurality of first network switches; and transmitting, by each first network switch among the plurality of first network switches, packets received from the plurality of second network switches to the plurality of network devices via the plurality of downlink ports.

Embodiment 12: The method for communicating of embodiment 11, further comprising: in connection with a set of multiple ports of each second switch, demultiplexing a respective fourth stream of packets received via a respective external network interface of the respective second IC switch chip to the set of multiple ports for transmission to one or more corresponding first network switches via respective communication links; and in connection with the set of multiple ports of each second switch, multiplexing at least a fifth stream of packets and a sixth stream of packets received via the set of multiple ports to the respective external network interface.

Embodiment 13: The method for communicating of embodiment 12, further comprising, for each second switch: multiplexing at least 500 sets of first incoming streams from at least 1000 first incoming streams of packets received via the at least 1000 ports to at least 500 respective second incoming streams; providing the at least 500 respective second incoming streams to at least 500 external network interfaces of the second IC switch chip; demultiplexing, at the second IC switch chip, the at least 500 second incoming streams of packets received via the at least 500 external network interfaces of the second IC switch chip to at least 1000 internal network interfaces of the second IC switch chip; multiplexing, at the second IC switch chip, at least 500 sets of first outgoing streams from at least 1000 first outgoing streams of packets received via the at least 1000 internal network interfaces of the second IC switch chip to the at least 500 second outgoing streams; providing the at least 500 respective second outgoing streams to the at least 500 external network interfaces of the second IC switch chip; and demultiplexing the at least 500 second outgoing streams of packets received via the at least 500 external network interfaces of the second IC switch chip to the at least 1000 ports of the second switch.

Embodiment 14: The method for communicating of embodiment 13, wherein, for each second switch: providing the at least 500 respective second incoming streams to the at least 500 external network interfaces of the second IC switch chip comprises providing each second incoming stream to a respective external network interface at a data rate of at least 200 gigabits per second (Gbps); and providing the at least 500 respective second outgoing streams to the at least 500 external network interfaces of the second IC switch chip comprises providing each second outgoing stream to a respective external network interface at the data rate of at least 200 Gbps.

Embodiment 15: The method for communicating of any of embodiments 11-14, wherein the method further comprises: in connection with demultiplexing each first stream of packets, i) demultiplexing the first stream or packets into at least a first substream and a second substream, ii) deinterleaving symbols of multiple forward error correction (FEC) codewords in the first substream, and iii) deinterleaving symbols of multiple FEC codewords in the second substream; and in connection with multiplexing each at least the second stream of packets and the third stream of packets, i) interleaving symbols of multiple FEC codewords in the second stream, and ii) interleaving symbols of multiple FEC codewords in the third stream.

Embodiment 16: The method for communicating of any of embodiments 11-15, further comprising, at each first switch: in connection with each uplink port of the first switch, demultiplexing a respective fourth stream of packets received via the uplink port to at least i) a respective external network interface of one first IC switch chip, and ii) a respective external network interface of another first IC switch chip; and in connection with each uplink port of the first switch, multiplexing at least i) a fifth stream of packets from the respective external network interface of the one first IC switch chip, and ii) a sixth stream of packets from the respective external network interface of the other first IC switch chip to a seventh stream of packets for transmission via the uplink port.

Embodiment 17: The method for communicating of embodiment 16, further comprising: in connection with each of at least 500 external network interfaces of each second IC switch chip, transferring packets from a respective port of the second IC switch to the external network interface at a data rate of at least 200 gigabits per second (Gbps); in connection with the each of the at least 500 external network interfaces of each second IC switch chip, demultiplexing the respective first stream of packets received via the external network interface to multiple internal network interfaces of the second IC switch chip from among at least 1000 internal network interfaces of the second IC switch chip; in connection with each external network interface of each second IC switch chip, multiplexing at least a second stream of packets and a third stream of packets received via multiple internal network interfaces among the at least 1000 internal network interfaces of the second IC switch chip to the external network interface; and in connection with each of at least 500 external network interfaces of each second IC switch chip, transferring packets from the external network interface of the second IC switch chip to the respective port of the second IC switch at the data rate of at least 200 Gbps.

Embodiment 18: The method for communicating of any of embodiments 11-17, wherein the respective IC package is a respective first IC package, wherein the plurality of internal network interfaces is a plurality of first internal network interfaces, wherein the plurality of external network interfaces is a plurality of first external network interfaces coupled to first external interconnects of the first IC package, wherein the packet processor is a first packet processor, wherein the plurality of multiplexer/demultiplexer circuitry is a plurality of first multiplexer/demultiplexer circuitry, and wherein each first IC switch chip of each first switch is included in a respective second IC package, further comprising: at each first switch, transferring packets received from the plurality of second switches to first set of second external network interfaces of the first IC switch chip; in connection with each second external network interface in the first set of second external network interfaces of each first IC switch chip, demultiplexing a respective fourth stream of packets received via the first external network interface to multiple second internal network interfaces of the first IC switch chip; at each first IC switch chip, forwarding packets received via the second internal network interfaces of the first IC switch chip amongst the second internal network interfaces of the first IC switch chip; and in connection with each second external network interface in the first set of second external network interfaces of each first IC switch chip, multiplexing at least a fifth stream of packets and a sixth stream of packets received via multiple second internal network interfaces of the first IC switch chip to the second external network interface.

Embodiment 19: The method for communicating of embodiment 18, further comprising, for each first switch: in connection with each of set of multiple downlink ports of the first switch among a plurality of sets of multiple downlink ports, multiplexing at least an eighth stream of packets and a ninth stream of packets received via the set of multiple downlink ports to a respective tenth stream of packets; in connection with each of set of multiple downlink ports of the first switch, transferring the tenth stream of packets to a respective second external network interface of the first IC switch chip; in connection with each second external network interface of the first IC switch chip, demultiplexing a respective eleventh stream of packets received via the second external network interface to at least a twelfth stream of packets and a thirteenth stream of packets; and in connection with each second external network interface of the first IC switch chip, transferring the at least the twelfth stream of packets and the thirteenth stream of packets to a respective set of multiple downlink ports of the first switch.

Embodiment 20: The method for communicating of one of embodiments 18 and 19, further comprising, for each first switch: transferring packets received from the plurality of second switches to the first set of second external network interfaces among at least 500 external network interfaces of the first IC switch chip; in connection with each second external network interface in the first set of second external network interfaces of each first IC switch chip, demultiplexing a respective fourth stream of packets received via the first external network interface to multiple second internal network interfaces among at least 1000 second internal network interfaces of the first IC switch chip; and at each first IC switch chip, forward packets received via the second internal network interfaces of the first IC switch chip amongst the at least 1000 second internal network interfaces of the first IC switch chip.

Some of the various blocks, operations, and techniques described above may be implemented utilizing hardware, a processor executing firmware instructions, a processor executing software instructions, or any suitable combination thereof. When implemented utilizing a processor executing software or firmware instructions, the software or firmware instructions may be stored in any suitable computer readable memory. The software or firmware instructions may include machine readable instructions that, when executed by one or more processors, cause the one or more processors to perform various acts such as described above.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A communication network, comprising:
a plurality of first switches, each first switch having i) a respective first integrated circuit (IC) switch chip having a plurality of network interfaces, ii) a respective plurality of downlink ports, and iii) a respective plurality of uplink ports; and
a plurality of second switches, each second switch having i) a respective plurality of ports coupled to at least one uplink port of each of the first switches, ii) a respective second IC switch chip in a respective IC package, the second IC switch chip having a plurality of external network interfaces coupled to external interconnects of the IC package, and iii) a respective plurality of serializers/deserializers (SERDES) to communicatively couple the respective plurality of external network interfaces to the respective plurality of ports of the second switch, each second IC switch chip further comprising:
a plurality of internal network interfaces,
a packet processor coupled to the plurality of internal network interfaces, the packet processor configured to forward packets amongst internal network interfaces of the plurality of internal network interfaces, and
a plurality of multiplexer/demultiplexer circuitry, each multiplexer/demultiplexer circuitry coupled to i) a respective external network interface, and ii) a respective set of multiple internal network interfaces, each multiplexer/demultiplexer circuitry configured to i) demultiplex a first data stream received from the respective external network interface into a second data stream and a third data stream for transfer to the respective set of multiple internal network interfaces, and ii) multiplex a fourth data stream and a fifth data stream received via the respective set of multiple internal network interfaces into a sixth data stream for transfer to the respective external network interface.

2. The communication network of claim 1, wherein the plurality of multiplexer/demultiplexer circuitry is a plurality of first multiplexer/demultiplexer circuitry, and wherein each second switch further comprises:
a respective plurality of second multiplexer/demultiplexer circuitry coupled to the respective plurality of SERDES, each second multiplexer/demultiplexer circuitry configured to i) demultiplex the sixth data stream received from a respective external network interface of the second IC switch chip via the SERDES into an eighth data stream and a ninth data stream for transmission via a respective pair of ports of the second switch, and ii) multiplex a tenth data stream and an eleventh data stream received via the respective pair of ports of the second switch into the first data stream for transmission to the respective external network interface of the second IC switch chip via the SERDES.

3. The communication network of claim 2, wherein:
each second IC switch chip includes at least 1000 internal network interfaces;
each second IC switch chip includes at least 500 external network interfaces; and
each second switch includes at least 1000 ports communicatively coupled to the at least 500 external network interfaces of the respective second IC switch chip.

4. The communication network of claim 1, wherein the plurality of SERDES is a plurality of first SERDES, and wherein each external network interface of the second IC switch chip comprises, or is coupled to:
a respective second SERDES coupled to the respective multiplexer/demultiplexer circuitry, the respective second SERDES configured to i) transfer the first data stream from the external network interface to the multiplexer/demultiplexer circuitry, and ii) transfer the sixth data stream from the multiplexer/demultiplexer circuitry to the external network interface.

5. The communication network of claim 1, wherein each multiplexer/demultiplexer circuitry comprises:
forward error correction (FEC) codeword interleaver circuitry configured to i) interleave symbols of multiple FEC codewords in the fourth data stream, and ii) and interleave symbols of multiple FEC codewords in the fifth data stream; and
FEC codeword deinterleaver circuitry configured to i) deinterleave symbols of multiple FEC codewords in the second data stream, and ii) deinterleave symbols of multiple FEC codewords in the third data stream.

6. The communication network of claim 1, wherein the plurality of SERDES is a plurality of first SERDES, wherein the plurality of multiplexer/demultiplexer circuitry is a plurality of first multiplexer/demultiplexer circuitry, and wherein each first switch further comprises:
at least two respective first IC switch chips; and
a respective plurality of second multiplexer/demultiplexer circuitry coupled to a respective plurality of second SERDES, each second multiplexer/demultiplexer circuitry configured to i) demultiplex a seventh data stream received via a respective uplink port into an eighth data stream and a ninth data stream for transmission to a respective pair of network interfaces of the first switch, and ii) multiplex a tenth data stream and an eleventh data stream received from the respective pair of network interfaces of the first switch into a twelfth data stream for transmission via the respective uplink port.

7. The communication network of claim 6, wherein:
each second IC switch chip includes at least 1000 internal network interfaces;
each second IC switch chip includes at least 500 external network interfaces;
each external network interface operates at a data rate of least 200 gigabits per second; and
each second switch includes at least 500 ports communicatively coupled to the at least 500 external network interfaces of the respective second IC switch chip.

8. The communication network of claim 1, wherein the respective IC package is a respective first IC package, wherein the plurality of internal network interfaces is a plurality of first internal network interfaces, wherein the plurality of external network interfaces is a plurality of first external network interfaces coupled to first external interconnects of the first IC package, wherein the packet processor is a first packet processor, wherein the plurality of multiplexer/demultiplexer circuitry is a plurality of first multiplexer/demultiplexer circuitry, and wherein each first IC switch chip of each first switch is included in a respective second IC package, each first IC switch chip including:
a plurality of second external network interfaces coupled to second external interconnects of the second IC package,
a plurality of second internal network interfaces,
a second packet processor coupled to the plurality of second internal network interfaces, the second packet processor configured to forward packets amongst second internal network interfaces of the plurality of second internal network interfaces, and
a plurality of second multiplexer/demultiplexer circuitry, each second multiplexer/demultiplexer circuitry coupled to i) a respective second external network interface, and ii) a respective set of multiple second internal network interfaces, each second multiplexer/demultiplexer circuitry configured to i) demultiplex a seventh data stream received from the respective second external network interface into an eighth data stream and a ninth data stream for transfer to the respective set of multiple second internal network interfaces, and ii) multiplex a tenth data stream and an eleventh data stream received via the respective set of multiple second internal network interfaces into a twelfth data stream for transfer to the respective second external network interface.

9. The communication network of claim 8, wherein the plurality of SERDES is a plurality of first SERDES, and wherein each first switch further comprises:
a plurality of second SERDES coupled to respective second external network interfaces that correspond to downlink ports of the first switch; and
a plurality of third multiplexer/demultiplexer circuitry coupled to the plurality of second SERDES, each third multiplexer/demultiplexer circuitry configured to i) demultiplex the twelfth data stream received from a respective second external network interface of the second IC switch chip via the respective second SERDES into a thirteenth data stream and a fourteenth data stream for transmission via a respective pair of downlink ports of the first switch, and ii) multiplex a fifteenth data stream and a sixteenth data stream received via the respective pair of downlink ports of the first switch into the seventh data stream for transmission to the respective second external network interface of the second IC switch chip via the respective third SERDES.

10. The communication network of claim 8, wherein:
each first IC switch chip includes at least 1000 second internal network interfaces;
each first IC switch chip includes at least 500 second external network interfaces; and
each first switch includes at least 500 downlink ports communicatively coupled to at least 250 second external network interfaces of the respective first IC switch chip.

11. A method for communicating in a communication network that includes i) a plurality of first network switches, and ii) a plurality of second network switches, each first network switch comprising i) a respective plurality of downlink ports, ii) a respective plurality of uplink ports, and iii) a respective one or more first integrated circuit (IC) switch chips communicatively coupled to the plurality of uplink ports and the plurality of downlink ports, and each second network switch comprising i) a respective plurality of ports coupled to at least one uplink port of each of the first network switches, and ii) a respective second IC switch chip communicatively coupled to the plurality of ports of the second switch, the method comprising:
receiving, at each first network switch among the plurality of first network switches, packets from network devices via the plurality of downlink ports;
forwarding, by each first network switch, packets received via the plurality of downlink ports to the plurality of second network switches via a respective plurality of communication links between the first network switch and each second network switch in the plurality of second switches;
at each second switch, transferring packets received from the plurality of first switches to external network interfaces of the second IC switch chip;
in connection with each external network interface of each second IC switch chip, demultiplexing a respective first stream of packets received via the external network interface to multiple internal network interfaces of the second IC switch chip;
at each second IC switch chip, forward packets received via the internal network interfaces of the second IC switch chip amongst the internal network interfaces of the second IC switch chip;
in connection with each external network interface of each second IC switch chip, multiplexing at least a second stream of packets and a third stream of packets received via multiple internal network interfaces of the second IC switch chip to the external network interface;
forwarding, by each second network switch, packets received from external network interfaces of the respective second IC switch chip to the plurality of first network switches via a respective plurality of communication links between the second network switch and each first network switch among the plurality of first network switches; and
transmitting, by each first network switch among the plurality of first network switches, packets received from the plurality of second network switches to the plurality of network devices via the plurality of downlink ports.

12. The method for communicating of claim 11, further comprising:
in connection with a set of multiple ports of each second switch, demultiplexing a respective fourth stream of packets received via a respective external network interface of the respective second IC switch chip to the set of multiple ports for transmission to one or more corresponding first network switches via respective communication links; and
in connection with the set of multiple ports of each second switch, multiplexing at least a fifth stream of packets and a sixth stream of packets received via the set of multiple ports to the respective external network interface.

13. The method for communicating of claim 12, further comprising, for each second switch:
multiplexing at least 500 sets of first incoming streams from at least 1000 first incoming streams of packets received via the at least 1000 ports to at least 500 respective second incoming streams;
providing the at least 500 respective second incoming streams to at least 500 external network interfaces of the second IC switch chip;
demultiplexing, at the second IC switch chip, the at least 500 second incoming streams of packets received via the at least 500 external network interfaces of the second IC switch chip to at least 1000 internal network interfaces of the second IC switch chip;
multiplexing, at the second IC switch chip, at least 500 sets of first outgoing streams from at least 1000 first outgoing streams of packets received via the at least 1000 internal network interfaces of the second IC switch chip to the at least 500 second outgoing streams;
providing the at least 500 respective second outgoing streams to the at least 500 external network interfaces of the second IC switch chip; and
demultiplexing the at least 500 second outgoing streams of packets received via the at least 500 external network interfaces of the second IC switch chip to the at least 1000 ports of the second switch.

14. The method for communicating of claim 13, wherein, for each second switch:
providing the at least 500 respective second incoming streams to the at least 500 external network interfaces of the second IC switch chip comprises providing each second incoming stream to a respective external network interface at a data rate of at least 200 gigabits per second (Gbps); and
providing the at least 500 respective second outgoing streams to the at least 500 external network interfaces of the second IC switch chip comprises providing each second outgoing stream to a respective external network interface at the data rate of at least 200 Gbps.

15. The method for communicating of claim 11, wherein the method further comprises:
in connection with demultiplexing each first stream of packets, i) demultiplexing the first stream or packets into at least a first substream and a second substream, ii) deinterleaving symbols of multiple forward error correction (FEC) codewords in the first substream, and iii) deinterleaving symbols of multiple FEC codewords in the second substream; and
in connection with multiplexing each at least the second stream of packets and the third stream of packets, i) interleaving symbols of multiple FEC codewords in the second stream, and ii) interleaving symbols of multiple FEC codewords in the third stream.

16. The method for communicating of claim 11, further comprising, at each first switch:
in connection with each uplink port of the first switch, demultiplexing a respective fourth stream of packets received via the uplink port to at least i) a respective external network interface of one first IC switch chip, and ii) a respective external network interface of another first IC switch chip; and
in connection with each uplink port of the first switch, multiplexing at least i) a fifth stream of packets from the respective external network interface of the one first IC switch chip, and ii) a sixth stream of packets from the respective external network interface of the other first IC switch chip to a seventh stream of packets for transmission via the uplink port.

17. The method for communicating of claim 16, further comprising:
in connection with each of at least 500 external network interfaces of each second IC switch chip, transferring packets from a respective port of the second IC switch to the external network interface at a data rate of at least 200 gigabits per second (Gbps);
in connection with the each of the at least 500 external network interfaces of each second IC switch chip, demultiplexing the respective first stream of packets received via the external network interface to multiple internal network interfaces of the second IC switch chip from among at least 1000 internal network interfaces of the second IC switch chip;
in connection with each external network interface of each second IC switch chip, multiplexing at least a second stream of packets and a third stream of packets received via multiple internal network interfaces among the at least 1000 internal network interfaces of the second IC switch chip to the external network interface; and
in connection with each of at least 500 external network interfaces of each second IC switch chip, transferring packets from the external network interface of the second IC switch chip to the respective port of the second IC switch at the data rate of at least 200 Gbps.

18. The method for communicating of claim 11, wherein the respective IC package is a respective first IC package, wherein the plurality of internal network interfaces is a plurality of first internal network interfaces, wherein the plurality of external network interfaces is a plurality of first external network interfaces coupled to first external interconnects of the first IC package, wherein the packet processor is a first packet processor, wherein the plurality of multiplexer/demultiplexer circuitry is a plurality of first multiplexer/demultiplexer circuitry, and wherein each first IC switch chip of each first switch is included in a respective second IC package, further comprising:
at each first switch, transferring packets received from the plurality of second switches to first set of second external network interfaces of the first IC switch chip;
in connection with each second external network interface in the first set of second external network interfaces of each first IC switch chip, demultiplexing a respective fourth stream of packets received via the first external network interface to multiple second internal network interfaces of the first IC switch chip;
at each first IC switch chip, forwarding packets received via the second internal network interfaces of the first IC switch chip amongst the second internal network interfaces of the first IC switch chip; and
in connection with each second external network interface in the first set of second external network interfaces of each first IC switch chip, multiplexing at least a fifth stream of packets and a sixth stream of packets received via multiple second internal network interfaces of the first IC switch chip to the second external network interface.

19. The method for communicating of claim 18, further comprising, for each first switch:
in connection with each of set of multiple downlink ports of the first switch among a plurality of sets of multiple downlink ports, multiplexing at least an eighth stream of packets and a ninth stream of packets received via the set of multiple downlink ports to a respective tenth stream of packets;
in connection with each of set of multiple downlink ports of the first switch, transferring the tenth stream of packets to a respective second external network interface of the first IC switch chip;
in connection with each second external network interface of the first IC switch chip, demultiplexing a respective eleventh stream of packets received via the second external network interface to at least a twelfth stream of packets and a thirteenth stream of packets; and
in connection with each second external network interface of the first IC switch chip, transferring the at least the twelfth stream of packets and the thirteenth stream of packets to a respective set of multiple downlink ports of the first switch.

20. The method for communicating of claim 18, further comprising, for each first switch:
transferring packets received from the plurality of second switches to the first set of second external network interfaces among at least 500 external network interfaces of the first IC switch chip;
in connection with each second external network interface in the first set of second external network interfaces of each first IC switch chip, demultiplexing a respective fourth stream of packets received via the first external network interface to multiple second internal network interfaces among at least 1000 second internal network interfaces of the first IC switch chip; and
at each first IC switch chip, forward packets received via the second internal network interfaces of the first IC switch chip amongst the at least 1000 second internal network interfaces of the first IC switch chip.
